(19) United States
(12) Patent Application Publication
(10) Pub. No.: US 2008/0019500 A1
(43) Pub. Date: Jan. 24, 2008

(54) Shared Call Center Systems and Methods (GigaPOP)

(76) Inventors: Oscar Pablo Torres, Buenos Aires (AR); Jorge Alfredo Recalde, Buenos Aires (AR); Bruce Sharpe, Aurora, CO (US); Joaquin Jares, Buenos Aires (AR); Martin H. Rosalin, Buenos Aires (AR); Aaron W. Seabaugh, Parker, CO (US); Brian R. James, Greenwood Village, CO (US); Timothy Silvera, Elizabeth, CO (US); Trevor Norcross, Denver, CO (US); Eric Buhring, Parker, CO (US); Keith Pelletier, Parker, CO (US); Michael Ringman, Littleton, CO (US); Timothy Hayes, Denver, CO (US); Todd Stott, Castle Rock, CO (US)

Correspondence Address: MERCHANT & GOULD PC, P.O. BOX 2903, MINNEAPOLIS, MN, 55402-0903, US

(21) Appl. No.: 11/556,003

(22) Filed: Nov. 2, 2006

Related U.S. Application Data
(60) Provisional application No. 60/733,051, filed on Nov. 2, 2005.
(60) Provisional application No. 60/763,070, filed on Jan. 27, 2006.

(51) Int. Cl. H04M 3/00

(52) U.S. Cl. 379/265.02

(57) ABSTRACT

Embodiments of the present invention relate to shared call centers. More particularly, embodiments of the present invention relate to a shared call center that is in electrical communication with one or more client call centers. The shared call center, in embodiments, provides monitoring of agent personnel, provides customization of agent desktop applications or provides evaluation of agent personnel.

### CROSS-REFERENCE TO RELATED APPLICATIONS

The present application claims priority to each of the following: U.S. Patent Application No. 60/733,051, entitled SHARED CALL CENTER SYSTEMS AND METHODS; U.S. patent application Ser. No. 11/287,548, entitled WEB-BASED VISUAL DEVELOPMENT ENVIRONMENT; U.S. Patent Application No. 60/763,070, entitled PERFORMANCE MONITORING; and U.S. patent application Ser. No. 11/291,759, entitled MONITORING SERVICE PERSONNEL, all of which are incorporated herein by reference for all that they disclose and teach.

### BACKGROUND

A call center typically consists of a large number of call center agents at desks with telephones. A call center is implemented to provide live agent help for a given organization. When an individual calls via a toll free or local number, the call is routed to the call center where the call is to be serviced. Agents working in the call center typically have access to certain applications of the organization so as to be able to provide relevant information to the customers or collect additional information as necessary.

An important hardware element used by call centers is the automatic call distributor (ACD). Although not necessary, there typically is an ACD in each call center. Calls arriving via the toll free or local telephone numbers are delivered by the public switched telephone network (PSTN) to the call center and associated ACD to which these numbers have been directed. The ACD is therefore responsible for receiving incoming calls from the PSTN and routing the calls to an appropriate agent. Calls are routed using any number of pre-defined routing strategies, such as delivering calls to the first available agent with a given skill set.

This traditional configuration requires specialized technical resources on staff at each call center to manage the ACD and associated components. In addition, one of the most expensive and time consuming components of building new call centers is the procurement and installation of the ACD. While a single ACD may be capable of managing a call center of up to 3,500 agents, operational and human resource constraints generally require that call centers are built much smaller, resulting in suboptimal utilization of the ACD infrastructure. Further, when using multiple ACDs, companies often have the challenge of managing software versions of multiple ACDs across multiple call center locations.

Management of the incoming telephone lines, or trunks, from the PSTN at each site also requires specialized technical resources. Provisioning or decommissioning these trunks can also be time consuming and costly as the volume of calls delivered to a given call center ramps up and down over time. This connection to the local PSTN is a significant ongoing cost within a call center, and each call center has a PSTN connection. Thus, the more call centers the higher the costs for the PSTN connections.

### SUMMARY

Embodiments of the present invention relate to shared call centers. More particularly, embodiments of the present invention relate to a shared call center that is in electrical communication with one or more client call centers. The shared call center, in embodiments, provides monitoring of agent personnel, provides customization of agent desktop applications or provides evaluation of agent personnel.

In embodiments, a shared call center is provided with an automatic call distribution function. In one embodiment, a monitoring system is also provided that includes a client communication device, a monitoring module, a client computer, and a media file to record data from agent sessions. The monitoring system uses information communicated in the shared call center to monitor the agents. Another embodiment of the invention comprises maintaining a library of code and a web-based development environment in the shared call center. The library and development environment, in embodiments, are used to create a customized application for an agent. In still another embodiment, performance metrics are defined for the agents and information in the shared call center is used to measure the performance of agents against the metrics.

This Summary only introduces a selection of concepts, about the embodiments of the present invention, in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

One or more embodiments of the invention will now be described with reference to the attached drawings in which:

FIG. 1 is a block diagram of an example implementation of a shared call server infrastructure provided by an embodiment of the invention.

FIG. 2 illustrates a logical representation of a network environment in which customers are provided web-based access to customer service sessions in accordance with an embodiment of the present invention.

FIG. 3 illustrates a system applicable for use in the network environment of FIG. 2 to provide customers with web-based applications for customer service interaction purposes in accordance with an embodiment of the present invention.

FIG. 4 is a flow diagram illustrating operational characteristics of a process for rendering a web-based visual development environment in the network environment of FIG. 2 in accordance with an embodiment of the present invention.

FIG. 5 is a flow diagram illustrating operational characteristics of a process for developing web-based software applications using the web-based development environment rendered in FIG. 4 in accordance with an embodiment of the present invention.

FIG. 6 is a conceptual depiction of a business model for performance management according to an embodiment of the present invention.

FIG. 7 is a flow diagram illustrating operational characteristics of a process, embodying the business model of FIG. 6, for managing the performance of an agent.

FIG. 8 is a network environment in which a software application for monitoring performance is implemented in accordance with an embodiment of the present invention.

FIG. 9 illustrates a logical representation of the performance management software application shown in the network environment of FIG. 8 in accordance with an embodiment of the present invention.

FIG. 10 is a flow diagram illustrating operational characteristics of a method for monitoring performance using the performance management software application shown in FIGS. 8 and 9 in accordance with an embodiment of the present invention.

FIG. 11 is a flow diagram illustrating operational characteristics performed by the performance management software application shown in FIGS. 8 and 9 to render display of interfaces to users of the software application in accordance with an embodiment of the present invention.

FIG. 12 generally illustrates in block diagram format an embodiment of a system that implements the business model shown in FIG. 6 and the software application shown in FIGS. 8 and 9.

FIG. 13 is a flow diagram illustrating operational characteristics of a process for monitoring performance and adjusting compensation in accordance with an embodiment of the present invention.

FIG. 14 illustrates a system for monitoring interaction between a customer service representative and a customer in accordance with an embodiment of the present invention.

FIG. 15 depicts a representation of the relation between recorded interactive data and recorded activity data in a media file created using the monitoring system shown in FIG. 14 in accordance with an embodiment of the present invention.

FIG. 16 is a flow diagram illustrating operational characteristics of a process for monitoring interaction between a customer service representative and a customer in accordance with an embodiment of the present invention.

FIG. 17 is a flow diagram illustrating operational characteristics of the monitoring process shown in FIG. 16 in more detail in accordance with an embodiment of the present invention.

FIG. 18 is a flow diagram illustrating operational characteristics of a process for monitoring interaction between a customer service representative and a customer in substantially real time in accordance with an embodiment of the present invention.

FIG. 19 is a block diagram illustrating an embodiment of a computing environment in which embodiments of the present invention execute.

### DETAILED DESCRIPTION

The present invention and its various embodiments are described in detail below with reference to the figures. When referring to these figures, like structures and elements shown throughout are indicated with like reference numerals. Software components, which may include routines, constructs and any other form of source or binary code or visual elements rendered therefrom, are logically and generally depicted in the figures using dashed lines.

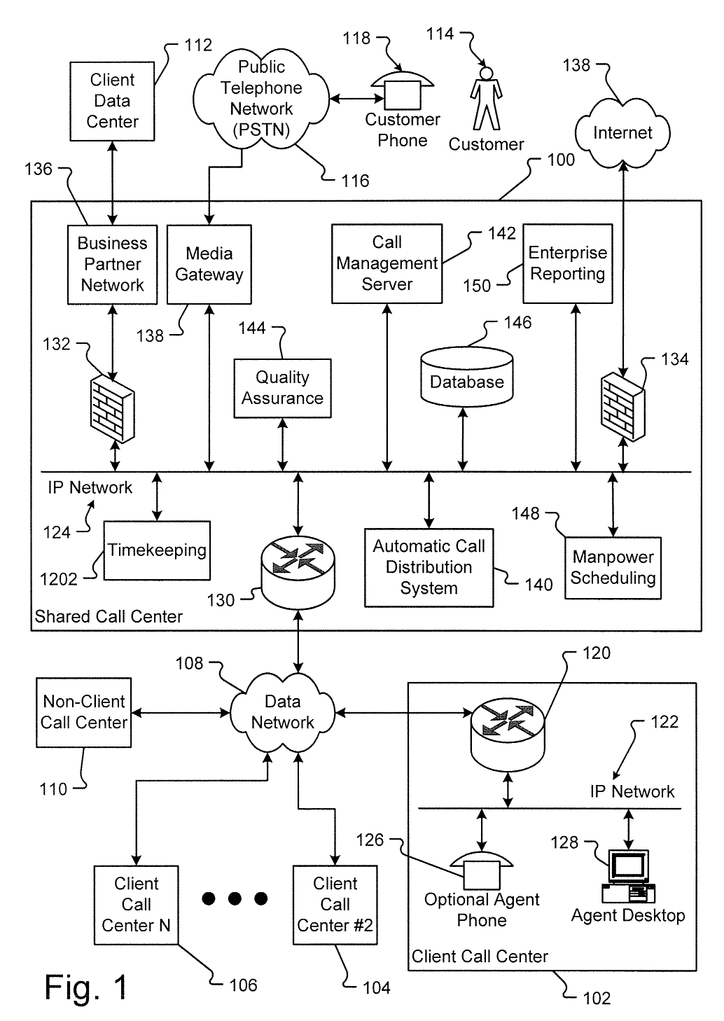

A shared and centralized call center infrastructure 100 is shown in FIG. 1. The call center infrastructure 100 is in electrical communication with one or more client-operated call centers 102, 104 and 106. In one embodiment, the call center infrastructure 100 and the client-operated call centers are connected through a data network 108. One embodiment of the data network 108 is a private network but can also embody other types of network connectivity such as the Internet.

The client-operated call centers 102, 104 and 106 may represent one or more clients for the shared call center infrastructure 100. In one embodiment, a call center is operated by a third party on behalf of a client, represented as non-client call center 110 also in electrical communication through the data network 108 to the shared call center infrastructure 100. There can be any arbitrary number of client call centers 102, 104 and 106, although only four client call centers are shown in FIG. 1. There also may be any arbitrary number of non-client call centers 110 although only one non-client call center is shown in FIG. 1.

In a further embodiment, a client data center 112 provides data to the shared call center, for example, new product information or marketing material. Typically there would be one or more such client data centers 112 for each client being served by the shared call center 100. There is only one such data center 112 shown in the illustrated example. Reference number 114 abstractly represents all customers who might be contacting any of the client call centers 102, 104 and 106 or non-client call centers 110. In some embodiments these customers 114 will access the call centers exclusively through toll free numbers. However, this one embodiment is not a requirement and local number access may be provided. Such calls from the customer's phone 118 are routed through the public telephone network 116 to the shared call center infrastructure 100. Finally, the shared call center infrastructure 100 is also shown with a connection to the Internet 138.

Unlike conventional call centers, each client call center does not include an ACD. Client call center 102 will be described now by way of example. Each client call center has a connection to the data network 108. In the illustrated example this is achieved through network router 120. However, any appropriate connection can be provided. The client call center 102 has a local network 122. In an exemplary embodiment of the invention, the networks 122 and 124 operate a client call center 102, a non-client call center 110 or the shared call center infrastructure 100 are Internet Protocol (IP) and all voice communications are voice over IP. Thus, in the illustrated example, the network 122 is an IP network. Each client call center 102, 104 or 106 then has a series of agent positions which each may optionally include an agent phone 126 and/or agent desktop machine 128 operable as a software phone. In one embodiment, both voice and data are transported over the same IP network 122. As described previously, the structure of the non-client call center 110 is similar to that of a client call center 102. The arrangement of FIG. 1 therefore allows a client to leverage consistent infrastructure, and thus technical and operational processes, across both client operated call centers 102, 104 or 106 and non-client operated call centers 110. The client data center 112 is external to the shared call center infrastructure 100, and is simply any infrastructure that a given client might have for managing their data and applications.

The shared call center infrastructure 100 will now be described in detail. Generally indicated at 130 are one or more network routers for making connections to client call centers, such as client call center 102, and more generally to the data network 108. The data network 108 is the point of access to and from the client database(s) and/or application(s) in the client call centers 102, 104 and 106. In an exemplary embodiment, there is a dedicated connection to each client call center, and the connection is private and secure. Thus, for the example shown in FIG. 1, there may be three such connections to three different client call centers, one for each client call center 102, 104 and 106. Furthermore, there may still be another connection to the non-client call center 110 for that client.

Firewall 132 is provided to give network security to the network of the shared call center infrastructure 100. Firewall 134 on the other end provides security between the shared call center infrastructure 100 and the Internet 138. In one embodiment, the remainder of the system shown in FIG. 1, including the shared call center infrastructure 100, the client call centers 102, 104 and 106, and the non-client call centers 110 are all behind either firewall 132 or 134. Implementing the system in this manner eliminates the need for additional firewalls in each call center 102, 104, 106, or 110, which in turn reduces the cost of building and operating the call centers 102, 104, 106, or 110. Firewalls 132 and 134 are combined with the security software inherent in the network routers 130 and 120 to provide network security for the IP network 124 and data network 108 running as part of the shared call center infrastructure 100.

Media gateway 138 is shown connected to the public telephone network 116 and is responsible for receiving voice media. It is noted that in conventional call centers, typically this voice media is left as voice and routed to agent workstations. In this embodiment, voice is converted to data and sent over data network 108. Thus, the media gateway 138 performs conversion to and from voice for the public telephone network 116 and the packet protocol run on the IP network 124. The media gateway 138 is capable of handling a large number of incoming calls simultaneously. In a preferred embodiment, the media gateway 138 is capable of handling up to 8000 different inputs. However, more generally the each media gateway 138 will be capable of handling some number of inputs, and as the volume of calls to be handled by the shared call center infrastructure 100 is increased, the infrastructure can be scaled simply by adding additional media gateways or by increasing the capacity of a given media gateway 138.

Automatic call distribution system 140 is responsible for call prompting, background music if employed, and for queuing calls for delivery to agent desktops 128 or phones 126. The automatic call distribution system 140 recognizes where each incoming call needs to be routed, namely to a particular call center or even to a particular agent, and routes the call to the appropriate agents, or queues the call for that agent. All of this is done using one of many pre-defined routing strategies such as “first available agent.” Each client call center will typically have one or more phone numbers that can be dialed, and the shared call center infrastructure 100 routes the calls to the appropriate call center 102, 104, 106, or 110 on the basis of the number dialed by the customer or the availability of agents to handle a call if a single phone number is used to serve across multiple call centers. The automatic call distribution system 140 also maintains knowledge of which agent stations are busy and which are available in a given call center 102, 104, 106, or 110, and, as such, can route an incoming call to an available agent. Once again, to increase the capacity of the system, a given automatic call distribution system 140 can be adapted to handle a larger number of calls, or additional automatic call distribution systems can be provided and connected to the IP network 124.

The call management server 142 is the statistical gatherer within the system 100. It watches the automatic call distribution system 140 and the media gateway 138 and collects statistics on calls served, such as average hold time and average handle time for each call. The call management server 142, in embodiments, allows reporting on operational efficiency, trend analysis, etc.

Quality assurance block 144 records calls for clients to enable quality to be monitored. Quality assurance 144 may also sample data flow of the applications being run to service customer requests, also known as “screen capture.” In some embodiments, Quality assurance 144 samples both voice and the display screen of the agent desktop.

The database 146 is intended to generically represent the data requirements of the shared call center infrastructure 100. The database 146, for example, is used to store the statistics and quality information or customer data, such as addresses and account numbers. However, more generally any appropriate information used by the system 100 can be stored in the database 146.

Manpower scheduling 148 is another component that allows each call center 102, 104, 106, or 110 to individually schedule its operation without the requirement for having an individual manpower scheduling tool in each call center 102, 104, 106, or 110. The manpower scheduler 148 allows multiple call centers 102, 104, 106, or 110 to be managed on a virtual basis.

In some embodiments, an enterprise reporting tool 150 is provided in the shared call center infrastructure 100. Enterprise reporting 150 is responsible for aggregating and reporting on data across multiple systems, such as the call management server 142, manpower scheduling 148, and quality assurance 144. The enterprise reporting tool 150 allows for a single, consistent view of operational metrics and further allows data to be analyzed taking into account the dependencies across multiple systems.

Also shown is a network router 130 through which the shared call center infrastructure 100 is connected to the data network 108. More generally, any appropriate mechanism for interconnecting the shared call center infrastructure 100 to the client or non-client call center infrastructures 102, 104, 106, or 110 can be employed. These connections are established to function as a dedicated network with security for each connection. In another embodiment, the public Internet or a similar public network is used in place of the data network 108, which, in embodiments, necessitates firewalls on each side of the network both at the shared call center infrastructure 100 and in each client call center 102, 104, or 106 and non-client call center 110. In another embodiment, the shared call center infrastructure 100 may also include interactive voice response (IVR) functionality. This can be provided on behalf of multiple clients.

By allowing a client call center 102, 104, or 106 or non-client call center 110 to be implemented without the up front capital cost of the technology provided in the shared infrastructure 100, a client call center 102, 104, or 106 or non-client call center 110 can be implemented with a very small number of agent seats without exorbitant costs. The shared infrastructure 100 also reduces the time to market since it removes the normal lead time associated with procuring and installing call center technology. Implementing a new client call center simply involves provisioning the equipment in the client call center 102, 104, or 106 and adding a new connection through data network 108 to the network router 130. Finally, the shared infrastructure 100 makes the technology location independent of the operations thus allowing greater flexibility in choosing ideal locations for call center construction since there is less need to consider the technical infrastructure or staff available in a given demographic area.

With further reference to the shared call center infrastructure 100, a very specific arrangement of functionalities has been shown. It is to be understood that this is only an example, and that more generally any arrangement of shared call center infrastructure 100 can be employed that is providing service to a collection of client call centers 102, 104, or 106 or non-client call center 110. It is noted that typically the client call centers 102, 104, or 106 or non-client call center 110 are remotely located, and can be located around the world so long as appropriate connections through the data network 108 can be established. These call centers may also range in size from thousands of agent positions to a single agent position used in a work-at-home environment.

The media gateway 138 and automatic call distribution system 140 are two features that are necessary to provide automatic call distribution functionality. The media gateway 138 and automatic call distribution system 140 can be implemented as one component, as two components as shown in the illustrated example, or as more than two components. The remaining functions, namely the call management server 142, quality assurance 144, database 146, manpower scheduling 148, and enterprise reporting 150 may be included in some embodiments, with each such component adding additional functionality to the system. However, the call management server 142, quality assurance 144, database 146, manpower scheduling 148, and enterprise reporting 150 are not essential to the basic provisioning of call center services. Furthermore, additional shared infrastructure beyond that shown in the example of FIG. 1 may alternatively or additionally be employed.

As an example of how the embodiment of FIG. 1 is employed to significantly affect a business's call center solution, consider the following example. Consider a company that now runs a set of call centers, for example three call centers located in three different geographies around the world. Each call center is running small switches or large switches etc. and has a lot of functionality reproduced in each call center. The collection and configuration of the call centers may have happened due to an acquisition of another company. To install and use the shared call center technology, the client eliminates the premise based ACDs and associated call center technology at each call center and migrates to a more efficient shared call center infrastructure 100 enabled using the embodiment of FIG. 1. The shared call center infrastructure 100 is a delivery point for customer calls, prioritizes those calls, and routes them for handling by the best possible client call center or non-client call center used by the single client. Some calls might be handled using high labor cost locations, while other low-value calls may be routed to client offshore locations for low-cost handling. As a result, each call is handled in an efficient and effective manner while operational loads are balanced across the call centers 102, 104, or 106. At the same time, centralized quality assurance 144 helps ensure a consistent customer experience across all three locations, while manpower scheduling 148 is done at an enterprise level to optimize the larger agent base and load balance across all call centers 102, 104, or 106. The client is able to use a single reporting engine, enterprise reporting 150, to pull consistent reports regarding the operations across all three facilities and all of the primary systems used within those call centers 102, 104, or 106.

In an exemplary embodiment, billing is based on actual usage of the shared infrastructure components and is calculated using data from components such as the call management server 142 and enterprise reporting 150. Billing of the infrastructure capacity provided by the shared call center infrastructure 100 can be done for example on a per seat, per month, and/or per functionality basis. In an embodiment, each client call center 102, 104, or 106 would receive a bill for the share of their expense of the shared call center infrastructure 100. The clients can pick and choose the functionality available from the shared call center infrastructure that each seat is to receive.

The agent seats in the client call center 102, 104, or 106, in some embodiments, have respective proprietary applications which run as a function of data collected from the client data centers. Alternatively, the agent workstations can simply be generic machines such as Internet browsers that are capable of running applications remotely served by the client data centers 112. In any case, the data to be used by agents and the voice communications between the customers and the agents are both routed through the data network 108 over a single network to the client call centers.

Further embodiments of the present invention are generally directed to a programming tool for facilitating the development of web-based customer service applications (hereinafter, “CSAs”), used by the agents on the agent desktop 128, and to improve the user interface environments of such applications. With that said, an exemplary embodiment involves creating a web-based application (e.g., website) having an internal or embedded graphical user interface that provides customers with access to customer service related information and tasks via rich user interface controls. In one embodiment, a customer or client access the database 146 to retrieve the application or other information. Further, the client, in embodiments, uses the client data center 112 to create the CSAs using the business partner network 136 that is part of the shared call center 100. However, it should be appreciated that the embodiments described herein are also applicable to concerns other than providing customer service.

In an embodiment, the creation of a web-based CSA does not involve the direct use of any programming code. Rather, application development occurs through the use of visual programming tools, such as, for example, dialogue boxes and drag-and-drop actions. Further, another embodiment of the present invention involves providing developers with web-based access to the visual programming tools. The present invention is hereinafter described in accordance with this embodiment and the visual development environment is consequently referred to as a “web-based VDE”. Because visual connecting, as opposed to programming code, is used in building web-based CSAs, the development of such applications may be accomplished by either software developers or non-software-developers, such as business analysts.

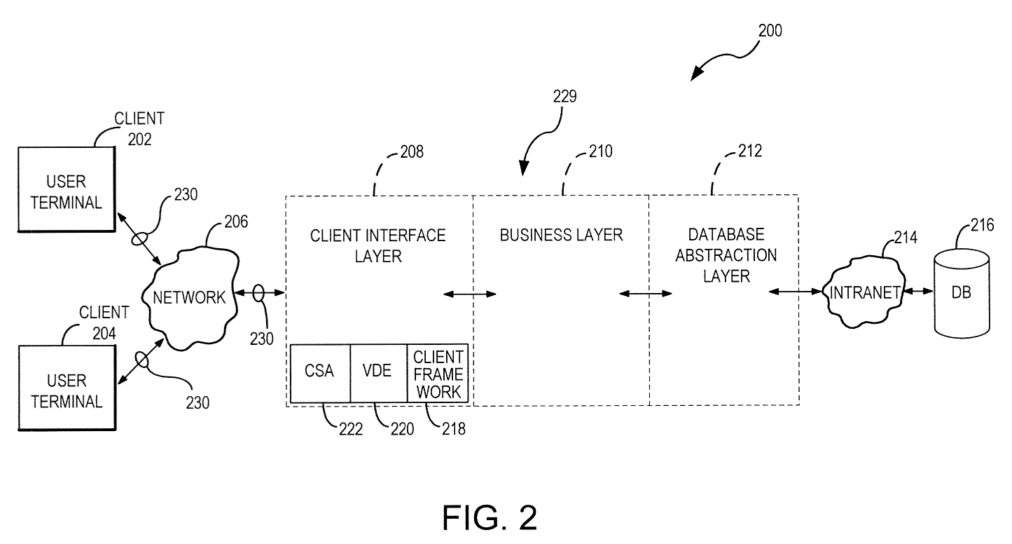

Based on this discussion of the general environment in which embodiments of the present invention are applicable, FIG. 2 illustrates, in block diagram form, a logical representation of a network environment 200 for providing customers with web-based access to CSAs in accordance with an embodiment of the present invention. Because FIG. 2 embodies a representation which is “logical” in nature, the network environment 200 is shown in FIG. 2 in general form using a block- and dashed-lines format. In an embodiment, the network environment 200 includes client computers 202 and 204 (hereinafter, “user terminals”), which, in embodiments, are part of the customer data center 112 (FIG. 1), a communication network 206 (hereinafter, “network”), such as the connection to the business partner network 136 (FIG. 1), an intranet 214, such as the connection IP network 124 (FIG. 1), a database 216, such as database 146 (FIG. 1), and a development system 224. The development center 224, in embodiments, is part of the business partner network 136 (FIG. 1), the call management server 142 (FIG. 1), or other component of the shared call center 100 (FIG. 1) and is made up of a client interface layer 208, a business layer 210 and a database abstraction layer 212.

The development system 224 is implemented on one or more server computers (not shown), and the three layers (208, 210, 212) of this system 224 interact with one another to provide functionality for creating web-based CSAs 222 and maintaining those web-based CSAs 222 for interaction by users over the network 206. Using dashed lines, the client interface layer 208, the business layer 210 and the database abstraction layer 212 are generally shown such as to not limit these layers to reside on any particular number of servers. Indeed, all three layers may alternatively reside on a single server or on separate servers (e.g., server farm), the implementation of which is a matter of choice.

As depicted in FIG. 2, the network environment 200 may be thought of as having two distinct components: “front-end” clients embodying the user terminals 202 and 204 and a “back-end” server on which the development system 224 is implemented. In accordance with an embodiment of the present invention, the server component can be a personal computer, a minicomputer, or a mainframe that performs, among other functions: data managing, client information sharing, administration functions related to the network, and security services. As noted, a server farm (not shown) may also be used. The network environment 200 is not limited to any particular implementation and instead embodies any computing environment upon which functionality of the environment may be practiced.

The “front end” user terminals 202 and 204 provide customer service providers and their customers access to the “back end” server for various forms of functionality. For example, customer service providers may use the user terminals 202 and 204 to interact with the development system 224 to create web-based customer service applications. On the other hand, their customers may use the development system 224 to interact with the web-based customer service applications 222 created by the customer service providers. Plainly stated, the user terminals 202 and 204 serve as “front-end” components that provide users with functionality to interact with the “back-end” development system 224 to either create or maintain a web-based customer service application or engage in a communication session therewith. For illustration purposes only, the network environment 200 is shown in FIG. 2 and described relative to connecting to only two user terminals 202 and 204; however, it should be appreciated that numerous user terminals may be connected to the network environment 200, and, thus, any number of user terminals 202 and 204 are contemplated to be part of the network environment 200.

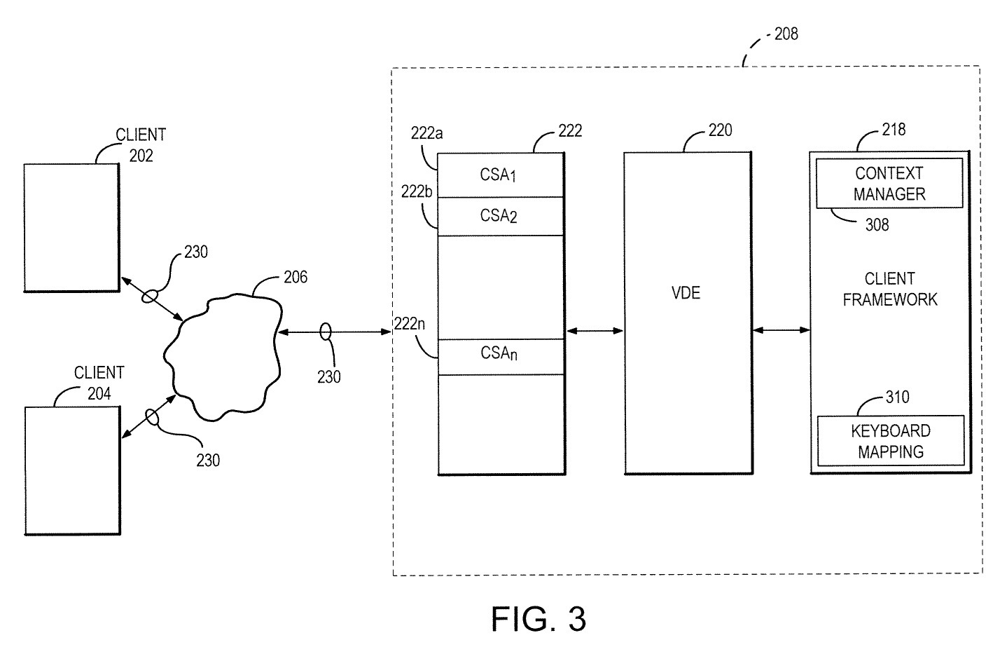

As shown in FIG. 2, the development system 224 is logically divided into three layers 208, 210, and 212, in which protocols at each layer provide certain functions or services as well as interact (shown via two-way arrows) with the protocols in the other layers to accomplish such services or functions. In accordance with an embodiment of the present invention, the client interface layer 208 comprises a Client Framework 218, a web-based visual development environment 220 (hereinafter “VDE”), and a plurality of web-based CSAs 222, exemplary depictions of which are shown in FIG. 3 and described below in conjunction therewith. As its name suggests, the client interface layer 208 interacts with the front-end clients, i.e., user terminals 202 and 204.

The client interface layer 208 links to the business layer 210. With respect to architectural levels, the business layer 210 may be any type of level conventionally known to those skilled in the art and described in accordance with an embodiment of the present invention as a layer which, in a broad sense, functions to process information through the use of various system components. As is well known in the art, various business layers exist which consist generally of a series of libraries and components to aid in the processing of information, or, as with respect to an embodiment of the present invention, to aid developers in the building of web-based CSAs 222. In processing information, the business layer 210 links to the database abstraction layer 212 which controls access to the database 216 (via intranet 214) and translates access requests into common database functionality such that the database environment can be changed without requiring changes to the system as a whole. In this sense, the database 216 may be any type of database environment, such as, but not limited to, an Oracle database or a Microsoft database (e.g., MS SQL Server).

The network 206 may be any type of network conventionally known to those skilled in the art. In accordance with an exemplary embodiment, the network may be a local area network, a wide area network, or a global network (e.g., the Internet or World Wide Web). In another embodiment, the network may be a private network, e.g., an intranet. While the network 206 may be any type of network conventionally known to those skilled in the art, the network 206 is described in accordance with an exemplary embodiment as the “World Wide Web” (i.e., “Web” for short). As such, communications over the network 206 occur according to one or more standard packet-based formats (e.g., H.323, IP, Ethernet, ATM).

Connectivity to the network 206 by the front-end user terminals 202 and 204 and back-end server(s) on which the development system 224 resides is accomplished using wire-based communication media, as shown using data communication links 230. The data communication links 230 may additionally, or alternatively, embody wireless communication technology. It should be appreciated that the manner of implementation in this regard is a matter of choice, and the present invention is not limited to one communication link over another, but, rather, wireless or wire-based technology may each be employed alone or in combination with the other.

Turning now to a more detailed illustration of the development system 224, FIG. 3 illustrates components of the client interface layer 208 and functionally depicts communication between the user terminals 202 and 204 and the client interface layer 208 via the network 206. Again, consistent with the logical representation of FIG. 2, the client interface layer 208 is shown in dashed-line form and the components of the client interface layer 208, namely the Client Framework 218, the web-based VDE 220, and web-based CSAs 222, are shown in block diagram form.

As depicted in FIG. 3, the user terminals 202 and 204 provide users with the ability to interact with the web-based CSAs 222 and the web-based VDE 220 over the network 206. The web-based VDE 220 provides a set of visual programming tools accessible to users by way of the network 206 for use in the development of software applications (e.g., web-based CSAs 222) by users of the user terminals 202 and 204. Thus, an embodiment of the present invention involves a customer service provider interacting with the web-based VDE 220 to create a web-based CSA 222 for use by their customers.

The web-based VDE 220 contains rich-user-interface visual and non-visual controls typical of those seen in traditional desktop environments. In this regard, the web-based VDE 220 has pre-built visual programming tools, including, but not limited to, drag-and-drop abilities, dialogues, visual wizards, icons, buttons, text boxes and/or other prompts. In essence, the user selects user interface controls by clicking on, or otherwise selecting, desired buttons, menus, icons, etc. With the drag-and-drop and selection of controls by use of buttons, menus, etc., users are able to visually connect the widgets on the screen. The web-based VDE 220 is thus a development environment for creating a rich user-interface for the web-based CSAs 222, (e.g., websites) through the use of these visual programming tools (e.g., drag-and-drop actions).

Using the pre-built visual programming tools of the web-based VDE 220, customer service providers are able to interact with the user terminals 202 and 204 to construct web-based CSAs 222, such as web-based CSA No. 1 (222a) and web-based CSA No. 2 (222b) shown in FIG. 3. Using the visual programming tools of the web-based VDE 220, customer service providers visually connect controls to build user interfaces for web-based CSAs 222a and 222b without the knowledge of the underlying code. In creating web-based CSAs 222 through the use of the visual programming tools, users select user interface controls for placement on the web-based CSAs 222 by invoking drag-and-drop functionality, dialog boxes, buttons, icons, menus, etc. In accordance with alternative embodiments, customer service providers may build web-based CSAs 222 solely on their own or with the assistance of an agent familiar with the particular features of the web-based VDE 220.

Once developed and deployed (i.e., made available for customer access), each web-based CSA 222 is maintained on the client interface layer 208 for access by the user terminals 202 and 204. During such interaction, a web-based CSA 222 may be configured to perform any action or provide any information relative to traditional customer service sessions, such as, for example, accept a bill payment, administer a “chat” session with a human customer service agent, accept and/or answer technical questions, provide account-specific information, etc. Indeed, the present invention is not limited to any particular type of information that may be provided or any type of action that may be performed. Rather, embodiments of the present invention are directed to the construction and maintenance of user interface controls within the web-based CSAs 222 using the web-based VDE 220 working in conjunction with the Client Framework 218, which is now described in detail below.

The Client Framework 218 embodies a software architecture framework consisting of a series of control libraries designed for the purpose of enabling developers to rapidly build rich user interfaces for the web-based CSAs 222. With that said, the control libraries provide user interface controls and methods for embedding the controls in the web-based CSAs 222 such that users are operable to manipulate the controls to request performance of actions through the user terminals 202 and/or 204 via the network 206. Exemplary controls include, but are not limited to, buttons for choosing options and scroll bars for moving through a document or positioning text.

The Client Framework 218 is designed to provide the web-based CSAs 222 with controls common to traditional desktop environments. Thus, from the client perspective, the Client Framework 218 enables an end user, or client, to work in a web-based CSA 222 that has the “look and feel” of a traditional desktop application. From the development perspective, the Client Framework 218, by way of its control libraries, provides the executable code (e.g., modular routines) required for implementation of these controls within the web-based CSAs 222. The componentized nature of the Client Framework 218 enables developers to rapidly create web-based CSAs 222 having rich user interfaces by requiring only that the developers refer to the names of the specific modular routines related to the desired controls, as opposed to building the code from scratch for each web-based CSA 222 being developed.

Describing now the interaction between a user terminal 202 and 204 and the client interface layer 208, a web-based CSA 222 or the web-based VDE 220 (depending on whether customer interaction or application development is being administered) is implemented on a “back-end” server communicatively connected to the network 206 and renders web pages on the user terminal 202 or 204. The Client Framework 218 and thus, the control libraries therein, are maintained on the “back-end” server during such interaction, but in an embodiment, all rendering of web pages occurs on a browser application residing on the user terminal 202 or 204. In an alternative embodiment, the present invention involves the executable code providing the user interface controls in the rendered web pages being maintained within the Client Framework 218 and not transmitted to, or otherwise being built on, the browser application.

Development of a web-based CSA 222 using the web-based VDE 220 only involves the selection of certain control features desired for a web-based CSA 222 under development by, for example, name input, control selection, and/or drag-and-drop selection for the specific modular routine upon which the desired control features are based. In response to such selection, the web-based VDE 220 employs the use of the Client Framework 218 to retrieve and incorporate the associated executable code for the selected control(s) into the source code for the web-based CSA 222 under development. Likewise, interaction between a user and a web-based CSA 222 involves the user manipulating user interface controls embedded within web pages being rendered on a browser application by a web-based CSA 222. In response to such manipulation, the web-based CSA 222 employs the Client Framework 218 to execute the code associated with each manipulated control resulting in the performance of some task that is communicated to the browser application.

In accordance with another embodiment, the executable code for each rendered control is cached to the user terminal 202 or 204 during interaction between a browser application implemented on that user terminal 202 and 204 and the client interface layer 208. In this embodiment, when a particular control is rendered, that control is fetched from the Client Framework 218 and provided to the browser application on the user terminal 202 or 204 unless the browser application already has that control cached. Thus, at run-time, when a control is initially requested for rendering on a web page in the browser application, the web-based CSA 222 (if customer is interacting with client interface layer 208 during a customer service session) or the web-based VDE 220 (if customer service provider is developing a web-based VDE 220) fetches the original lines of code stored in the Client Framework 218 and provides this fetched code to the browser application for caching, rendering and interpretation by a browser-specific interpreter, such as, for example, a JavaScript interpreter. In any subsequent requests to render that control, the web-based CSA 222 or the web-based VDE 220 (depending on interaction type, as described above) does not access the Client Framework 218, but rather directs the browser application to execute the associated code from cache.

Because all rendering occurs on the browser application in accordance with this latter embodiment, all programming code stored in the Client Framework 218 and provided to the browser application must be compatible with the particular browser being used by the user terminals 202 and 204. Examples of common browsers are Netscape Navigator and Internet Explorer. The application sent to the browser uses both standard, e.g., JavaScript, XML, and non-standard protocols capable of interpretation by standard browsers, e.g., Microsoft Internet Explorer, version 6.0. The browser changes the script to standard hyper-text markup language (HTML) for rendering on the display of the user terminal 202 and 204. Alternatively, the application may be written in standard HTML code. The Client Framework 218 is thus comprised of a series of libraries consisting of browser-specific code, such as, by way of example, HTML and JavaScript code, which is organized with a basic structure designed to enable developers to rapidly build web-based CSAs 222 with rich user interfaces typical of traditional desktop environments.

The primary functions of the Client Framework 218 are thus two-fold. First, the Client Framework 218 is designed to enable developers to build web-based CSAs 222 with traditional desktop controls. Second, the Client Framework 218 is designed to enable the rapid development of these web-based CSAs 222. Turning to the first main function, Client Framework 218 stores a plurality of user interface controls. Examples of such controls include, but are not limited to: drop-down lists and menus, tab controls, tree controls, slider panels, animation, toggle buttons, etc. Because, as noted, the present invention provides for the rendering of such rich, interactive controls in a browser application, the coding in the libraries of the Client Framework 218 is built from a series of non-visual controls native to the particular browsers and browser versions available, including, but not limited to, Internet Explorer 6.0.

The Client Framework 218 is thus designed to detect the type and version of browser application. As noted, a browser application has native components, or native HTML tags, built into it to control the display of text or controls on particular web pages. By way of example, and for purposes of illustration only, it is noted that one such native component is the <div> tag. Component developers of the Client Framework 218 organize multiple <div> tags in such a way as to create non-native visual controls on the browser-based application. By using multiple lines of code built from native controls, such as the <div> tag, developers are able to build code for rendering rich, interactive user interface controls in web-based CSAs 222. The developers store and maintain this code in the Client Framework 218 so that functionality is properly carried over into the client-side application when the end user pulls up an application. If necessary, this code is interpreted with an appropriate browser-specific interpreter every time it is fetched from the server to the browser.

With respect to the second main function, the Client Framework 218 is designed to enable the rapid development of these rich, interactive web-based CSAs 222 by using modular software routines, or components. The original lines of code for the control libraries are condensed into a single line of code or other section of code, also referred to as a modular routine, which can be invoked by referring to the name associated with that function. In this sense, the controls of the Client Framework 218 are said to be “componentized.” By componentizing this code, a web developer using Client Framework 218 need only type the lines of code necessary to call and send data to and from the desired control and need not understand the underlying code of the control to administer such use. Once called, the underlying executable code for the control is fetched from the Client Framework 218 and original lines of code are cached, implemented and interpreted with the browser interpreter.

As shown in FIG. 3, the Client Framework 218 includes a context manager control 308 and a keyboard mapping control 310, which are code modules in a control library that provide exemplary controls available for selection by a user through the web-based VDE 220 for inclusion in a user interface internal to a web-based CSA 222, As in traditional desktop applications, the context manager control 308 is a specific modular routine for making the other visual and non-visual controls, (e.g., buttons, menus, icons, tree controls, etc.,) context-sensitive. (It is worth noting that controls may be built upon and within other controls.) Context-sensitivity means that the particular options associated with a particular control are made functional or non-functional, or activated or deactivated, depending on the context of the particular control, as programmed in a pre-determined fashion by the developers of context manager control 308.

For example, and in accordance with an embodiment of this invention, a user may select “real estate” from a tree control. When this control is selected, certain menu options and buttons, among other things, may be deactivated or made non-functional, such as the print button or print option in the file menu. Because virtually an unlimited host of controls may be created in web-based CSAs 222 to emulate the seemingly endless number of controls potentially available in desktop applications, there are numerous context-sensitive parameters which may be made in context manager control 308. The present invention is not limited to any particular user interface controls, which may also be referred to in the art as “components.”

Another example of a rich-user-interface control available in these web-development applications is the keyboard mapping control 310. In a typical desktop environment, programmed code exists which allows a user to change the functionality of the keyboard keys to the specific uses or combinations desired by the particular user. For example, while CTRL-P is a common keystroke combination for invoking the “Print” command, a user may change the assigned calling keystroke combination to CTRL-Q, for example. Thus, with the use of Client Framework 218 and web-based VDE 220, keyboard mapping can be used in the web-based world. Such a feature not only improves the usability of the web-based CSA 222 within which it is used, but also the speed with which users familiar with keyboard mapping can create web-based CSAs 222.

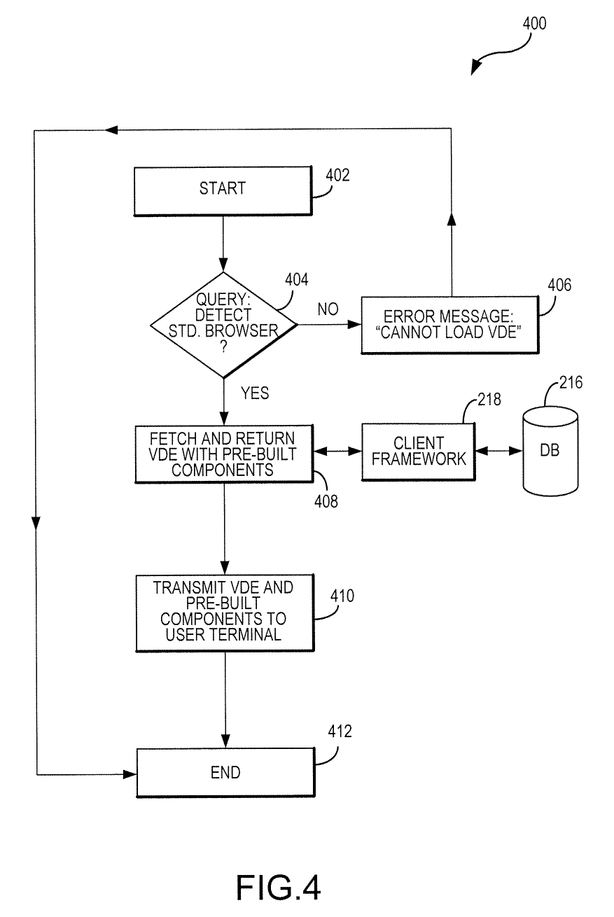

Turning now to FIG. 4, a process 400 for rendering the web-based VDE 220 on a browser application for use in creating a web-based CSA 222 is shown in accordance with an embodiment of the present invention. As such, the rendering process 400 is described in an exemplary embodiment as being performed by the development system 224, and more particularly, components of the client interface layer 208. For illustration purposes, the browser application is described herein as being implemented on one of the user terminals 202 and 204. However, in accordance with an alternative embodiment, the browser application may be implemented on a user terminal locally connected to the development system 224 by way of the intranet 214. Such an embodiment is particularly useful in circumstances wherein a customer service provider employs an agent or contractor to build a web-based CSA 222 on its behalf. Regardless of implementation, the rendering process 400 is performed using an operation flow that begins with a start operation 402 and ends with a terminate operation 412.

The start operation 402 is initiated in response to receipt of a request by a user (e.g., a customer service provider) to launch the web-based VDE 220. In an embodiment, such a request is received over the network 206 and involves the user interacting with a browser application maintained on the user terminal 202 or 204 to log onto the development system 224, which as noted above, resides on one or more servers connected to the network 206. For example, the user may effectuate such a request by entering a uniform request locator (URL) assigned to the development system 224 in the browser application.

Once initiated, the operation flow of the rendering process 400 passes from the start operation 402 to a query operation 404. The query operation 404 determines whether the browser application is based upon standard protocols and, thus, operable to interpret controls provided by the Client Framework 218. If a standard-protocol-based browser application is not detected, the query operation 404 passes the operation flow to a message operation 406, which displays an error message within the browser application (e.g., using an HTML page) that indicates that the web-based VDE 220 cannot be loaded into that particular browser application. The operation flow of the rendering process 400 then concludes at the terminate operation 412. On the other hand, if a standard browser is detected, the query operation 404 passes the operation flow to a fetch and return operation 408. The fetch and return operation 408 fetches and returns the web-based VDE 220 with visual programming tools and identifiers for a plurality of user interfaces controls from the control libraries which as noted above, are maintained by the Client Framework 218.

The operation flow then passes from the fetch and return operation 408 to a transmit operation 410, which transmits the scripting language and other code embodying the web-based VDE 220, including the visual programming tools and identifiers, to the user terminal 202 or 204 for rendering in the browser application. The web-based VDE 220 embodies standard protocol-based scripting languages, which once received by the browser application are interpreted into standard HTML or XML code and rendered therein. With the web-based VDE 220 launched and the rich user interface of this application displayed to the user through the user terminal 202 or 204, the operation flow of the rendering process 400 concludes at the terminate operation 412.

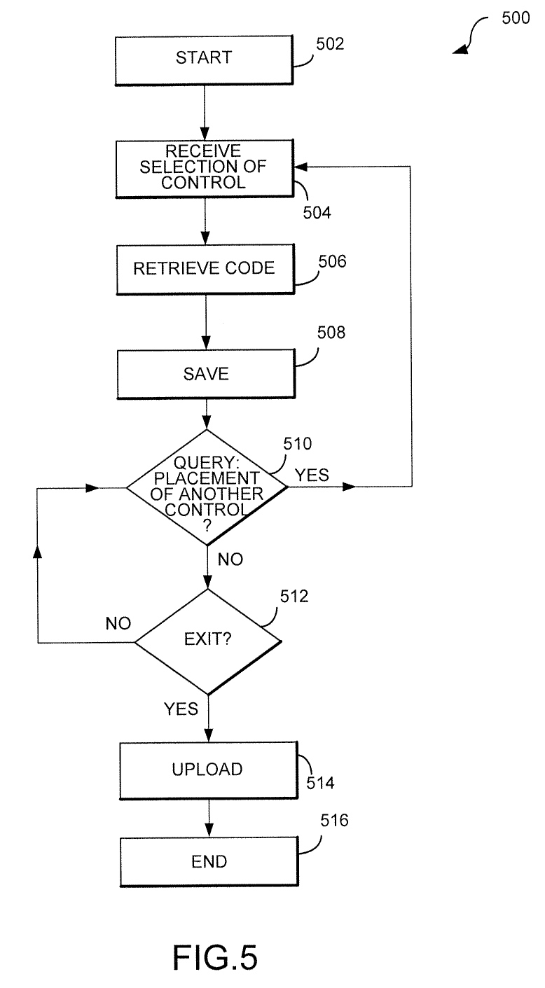

Turning now to FIG. 5, a process 500 for developing a web-based CSA 222 using the web-based VDE 220 is shown in accordance with an embodiment of the present invention. Accordingly, the development process 500 is described herein with reference to developing a web-based CSA 222 using the web-based VDE 220 rendered by the rendering process 400 shown in FIG. 4. The development process 500 is thus described in accordance with an exemplary embodiment as being performed using an operation flow that begins with start operation 502 initiated following the transmit operation 410. From the start operation 502, the operation flow of this process 500 proceeds to a receive operation 504.

The receive operation 504 receives selection of a control by way of a visual programming tool displayed within the browser application (on the user terminal 202 or 204) on the rendered web-based VDE 220. In an embodiment, such selection is accomplished by the user dragging-and-dropping an identifier representing the selected control onto a development workspace using a mouse or other interface selection object (e.g., joystick, keyboard, etc.). From the receive operation 504, the operation flow passes to a retrieve operation 506. The retrieve operation 506 retrieves the executable code associated with the selected control by accessing one or more control libraries maintained on the Client Framework 218. The executable code embodies a sequence of instructions which, when practiced, renders a desired functionality (e.g., performance of an action) associated with the selected control. In an embodiment, the control libraries are normally stored on the Database 216 and, in response to invocation of the development system 224, are retrieved by the data abstraction layer 212 and cached on the Client Framework 218 thereon for use only during the current development session.

After the executable code associated with the selected control has been retrieved, the operation flow passes to a save operation 508. The save operation 508 saves the retrieved executable code to source code for the web-based CSA 222 under development such that, when accessed by a user (e.g., customer) over the network 206, the user is presented with a web page having that selected control. From the save operation 508, the operation flow passes to a first query operation 510. The first query operation 510 determines whether the user has selected of another control for inclusion in the web-based CSA 222 (e.g., by dragging-and-dropping). If so, the operation flow passes back to the receive operation 504 and continues as described above. Otherwise, the first query operation 510 passes the operation flow to a second query operation 512.

The second query operation 512 determines whether the user has indicated a desire to close or exit the web-based VDE 220 and, upon such an indication, passes the operation flow to an upload operation 514, which is described below. However, if the second query operation 512 has not detected an indication to close or exit the web-based VDE 220, the operation flow passes back to the first query operation 510 and continues in a loop between the first (510) and the second (512) query operations until either another control is selected or the user decides to exit the web-based VDE 220. The upload operation 514 stores the web-based CSA 222 to memory on the client interface layer 208 and assigns the web-based CSA 222 a URL or other identifying address for use by users to request access to the web-based CSA 222. From the upload operation 514, the operation flow of the development process 500 concludes at a terminate operation 516.

Selection of controls is described as being accomplished using the development process 500 of FIG. 5 by way of drag-and-drop actions. However, other forms of selection are contemplated to be within the scope of the present invention including, without limitation, dialogues, visual wizards, prompts, and text boxes. Additionally, the order of operations shown in FIGS. 4 and 5 is provided for illustrative purposes only and, in accordance with other embodiments, may be modified or performed simultaneously. Furthermore, it should be appreciated that the scope of the present invention accommodates other operations that may be added or removed depending on the needs of the entity (e.g., customer service provider) for which a web-based CSA 222 is being developed.

Other embodiments of the present invention are directed to monitoring performance of employees, contractors and other agents employed to perform tasks on behalf of a company, business organization or other entity. In an embodiment, the present invention involves an approach for integrating performance management techniques with compensation practices, thereby creating an innovative rewards system to drive results from these individuals, which, for simplicity, are collectively referred to herein as “agents.” The agents, in embodiments, are the personnel that interface with customers using the shared call center 100. While designed to inspire and motivate agents to achieve strategic goals in the client service industry (i.e., for an organization's clients), this approach also creates an effective platform for coaching employees to increase performance. With respect to the former, the present invention results in performance management being a daily, weekly, and/or monthly event.

The present invention, in embodiments, also provides for incentivizing agents that are paid with an hourly wage or another form of a fixed salary. Previously, it has been difficult to motivate fixed salary agents based on their base pay. Using embodiments of the present invention described below, hourly or fixed salary agents have adjustments or changes to their base salary (pay) tied to their performance in relation to metrics aligned with goals of an organization. If an agent continues to perform at increasingly higher levels of performance, their base salary will increase. In some embodiments, if an agent's performance continually declines their base salary will decrease. These adjustments can be designed to occur automatically, without any input from a supervisor, so that an agent can feel confident that once they reach a particular level of performance, they are guaranteed an increase in their salary.

The performance management approach involves monitoring performance of certain tasks by agents against a defined set of metrics that are linked to financial aspects concerning the agents over a given period in time. With respect to customer service agents and teams, exemplary metrics include, but are not limited to, call resolution statistics (e.g., statistics that relate to the extent to which a customer service agent or team of agents resolve calls without customers having to call back, i.e., “first call resolution”), customer satisfaction statistics, revenue statistics, attrition statistics, call reduction statistics (e.g., statistics that relate to whether a customer service agent or team of agents address customers' multiple concerns or questions in a single call) and quality assessment statistics. In accordance with an embodiment, the financial aspects relate to compensation such as, for example, variable compensation and base compensation, thereby providing an indication of individual performance relative to compensatory expectations. For example, while one agent's monthly performance may be exceptional relative to his or her compensation for that month; another agent having the same exact monthly performance may lag behind expectations because of his or her higher compensation. In addition to monitoring individual agent performance, the present invention also relates to monitoring performance of a group of agents as a whole such as for example, a team of agents or a company or other business entity. For illustrative purposes, these “agents” are described herein as being customer service agents employed by an “outsourcing” company to perform customer service tasks for a “client” company, however the present invention is not limited thereto.

In accordance with this illustrative embodiment, the performance management approach of the present invention generally provides inspiration and motivation for agents to achieve the strategic goals of the client company. Not only does performance management become a daily, weekly, and/or monthly event, but this approach provides an effective platform for training and coaching. In an embodiment, the performance management approach is implemented on a computer-based system, such as on the quality assurance component 144 (FIG. 1), manpower scheduling 148 (FIG. 1), or other component of the shared call center 100 (FIG. 1), and available to agents, team leaders (e.g., supervisors) and management to access at any given time. However, Applicant's inventive concept for performance management is also applicable in non-computing environments. Accordingly, the present invention is embodied in a conceptual business model in addition to a computer-based implementation, each of which is described in turn below and then described in detail as combined with one another.

In an embodiment, the performance management (PM) business model 680, which in commerce is referred to as “Optimum Rewards™,” is based on a componentized framework having a “performance metric” component 682, a “variable pay” component 684 and a “base pay” component 686. The performance metric component 682 involves processes that set metrics, communicate essential skills, knowledge, and behaviors, provide feedback and coaching, and deliver rewards, which offers agents what they need to excel in their work. The defined metrics may relate to any performance consideration and, in an embodiment, are based on strategic goals and expectations with regard to tasks that agents are employed to perform on behalf of an organization. In alternative embodiments, the metric relates to tasks that agents are employed to perform on behalf of a client of the organization. Such business relationships are common particularly in the customer service industry in which contracting companies employ customer service agents to take calls from other companies' customers. However, the PM business model 680 is useful in any relationship where an agent is employed to perform tasks.

Referring back to the componentized framework, the variable pay component 684 determines whether and to what extent an agent is entitled to variable pay based on their achievement level of defined performance metrics for a period of time (e.g., daily, weekly, or monthly). The base pay component 686 determines each agent's base compensation package by taking into account each agent's consistent level of achievement over time (e.g., daily, weekly, or monthly). The performance metric component 682, the variable pay component 684 and the base pay component 686 are further described below in turn:

The performance metric component 682 provides a systematic process to set metrics, communicate essential skills, knowledge, and behaviors, provide feedback and coaching, and deliver rewards, which offers employees what they need to excel in their work. Performance management thus becomes self-directed in that employees are given access to near real-time performance and tools to increase performance at their desktop. Furthermore, this component allows performance management to be near real-time and focused on improving monthly performance.

In an embodiment, the variable pay component 684 rewards agents based on their achievement level of defined performance metrics each month. Examples of features of the variable pay component 684, for one embodiment, are provided below:
1) Two to four key performance metrics are chosen that align individual agent performance with a company's strategic goals which produces desired results.
2) Within the plan design, four achievement levels are defined, which focuses agents on achieving a higher level of performance each month.
3) To qualify for a specific achievement level, participants must achieve the required results for all chosen key performance metrics.
4) In addition to individual achievement levels, team modifiers can be added to the plan to reward team success. Only team members who receive an individual award are eligible for the team award modifier.
5) To be eligible for variable pay, employees must meet a schedule adherence goal, which acts as a trigger for any variable pay payment.

In an embodiment, the base pay component 686 is linked to an agent's consistent level of achievement over time. Examples of features of the base pay component 686, for an embodiment, are provided below:
1) Agents are paid an initial hourly base pay rate corresponding to a performance level.
2) Agents' hourly base pay rate is subject to increases or decreases which are linked to consistent achievement of the chosen key performance metrics.
3) In order to receive a base pay rate increase, agents must achieve a higher level of performance than the level corresponding to their current pay for three consecutive months. Similarly, an agent's base pay rate will be decreased in the event that their level of performance falls below the associated performance level of their current base pay rate for two consecutive months.

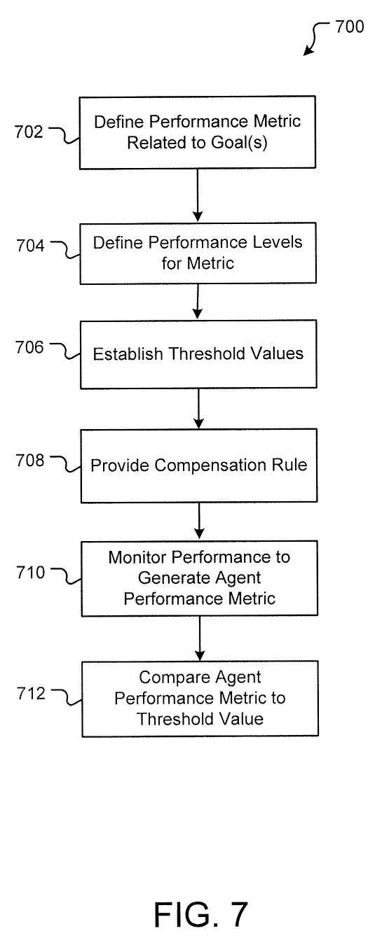

In some embodiments, the PM business model 680 is embodied in a number of different methods that may relate for example to managing the performance of an agent and providing incentives to an agent to increase their performance. As one example, FIG. 7 is a flow diagram illustrating operational characteristics of a method 700, embodying the PM business model 680, for managing the performance of an agent. The method 700 is described below with reference to only one agent and one metric for simplicity purposes; however, it should be appreciated that in some embodiments the process is practiced in numerous instances for each agent in an organization and may involve defining a number of different metrics. Moreover, the process is described with respect to an agent employed by an organization. However, in other embodiments it is applied to an agent employed by an organization to perform tasks for a client of the organization. It should be understood that although the steps of method 700 are described in a particular order, in other embodiments some of the steps may be performed in a different order.

Method 700 begins with a define step 702, which defines a metric that is related to a goal of an organization. The metric is a measurable quantity that correlates to achieving a specific goal of an organization. For example, in one embodiment an organization may have a goal to reduce the number of service calls that a customer must make to get an issue resolved. A metric that may be defined (at step 702) that relates to that goal may be referred to as “first call resolution,” which is measured by how many customers call a second time, within 120 hours, after calling a first time. As another example, an organization may have a goal of increasing revenue. A metric that may be defined (at step 702) that relates to that goal may be referred to as “cross-selling,” which is measured by sales revenue generated from customer service calls. These are merely some examples of metrics that may be defined in relation to goals of an organization. Those with skill in the art will appreciate that the specific metrics defined at step 702 will relate to the specific goals of the organization and are not limited to the examples described above.

After step 702, a second define step 704, is performed to define a plurality of performance levels for the performance metric defined at step 702. The performance levels are intended to represent a relative level of performance of an agent for the metric defined in step 702. In one embodiment, the performance levels may be defined as below satisfactory, satisfactory, above satisfactory and exceptional. As those with skill in the art will appreciate, the number of levels as well as the labels applied to the levels is a matter of preference and any number of levels referred to with any label may be defined at step 704. Each of the performance levels defined at step 704 is associated with a threshold value for the performance metric. The threshold values are established at step 706. At step 706, the threshold values associated with the performance levels defined at step 704 are established based on a current compensation provided to the agent. The threshold values are values that an agent must achieve, for a defined metric, in order for their performance to be classified/categorized within one of the defined performance levels. In one embodiment, average call handling time may be defined as a metric, and the performance levels may be defined as below satisfactory, satisfactory, above satisfactory, and exceptional. In this embodiment, at step 706, thresholds of: >360 seconds, 360 seconds, 340 seconds and 320 seconds are established for the defined performance levels of: below satisfactory, satisfactory, above satisfactory, and exceptional, respectively. Accordingly, for an agent's performance to be classified as satisfactory they must have an average call time that does not exceed the 360 second threshold. If an agent's average call time is less than the 320 second threshold, their performance will be classified as exceptional.

The threshold values established at step 706 are established based on a relative compensation of an agent. For example, if a first agent has a higher compensation than a second agent, the thresholds established for the first agent will require a better agent performance for each performance level in order to reflect the higher compensation of the first agent. From the perspective of an organization, setting of the threshold values in relation to compensation is an effective way to tie an agent's compensation to performance. Referring back to the previous example, an agent that is compensated at a higher level may have average call handling time thresholds established at step 706 of: >340 seconds, 320 seconds, 310 seconds and 300 seconds for the defined performance levels of: below satisfactory, satisfactory, above satisfactory, and exceptional, respectively.

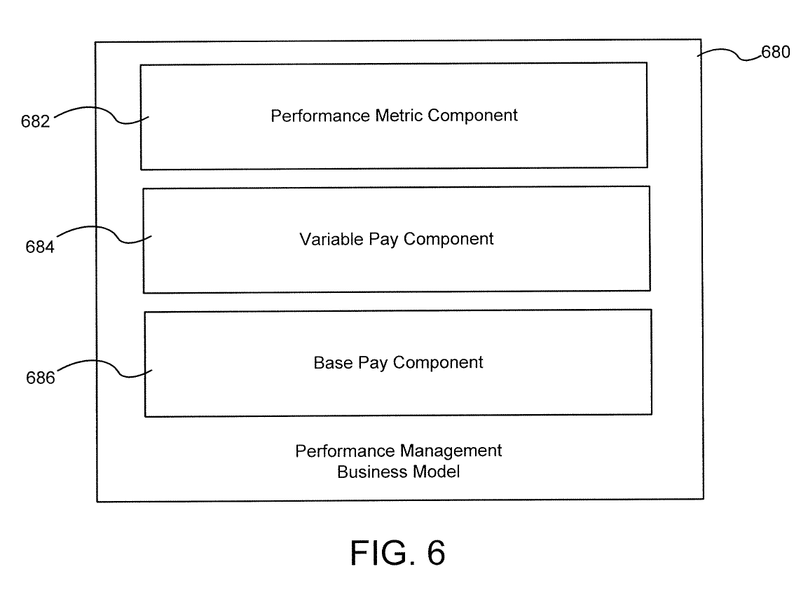

After the threshold values have been established at step 706, a compensation rule is provided at step 708. The compensation rule defines which of the performance levels an agent must achieve to change their current compensation. The change may be an increase or a decrease in the current compensation of an agent. In one embodiment, the compensation rule may provide for increasing the compensation of an agent if an agent achieves a performance level above the satisfactory performance level. In an alternative embodiment, the compensation rule may provide for decreasing the compensation of an agent if an agent achieves the below satisfactory performance level. In some embodiments, the change in compensation may be reflected in the variable component 684, described above with respect FIG. 6, such as may be the case when providing a bonus to an agent who achieves a performance level above the satisfactory performance level. In other embodiments, the change in compensation may be reflected in the base pay component 686, described above with respect to FIG. 6.

In some embodiments, the compensation rule may define a time over which an agent must achieve a particular performance level to change their current compensation. For example, the compensation rule may define that an agent must achieve a performance level above the satisfactory performance level for a month to increase their current compensation. In another example, the compensation rule may define that an agent must achieve a performance level below the satisfactory performance level for two consecutive months to have their compensation reduced. In some embodiments, the compensation rule may define two or more periods of time over which an agent must achieve a particular performance level to change their current compensation. In one embodiment, a compensation rule may define a first time (e.g., a month) over which an agent must achieve a level above the satisfactory level to receive a bonus; a second time (e.g. three months) over which an agent must achieve a performance level above the satisfactory performance level to increase their base salary; and a third time (e.g. two months) over which an agent must achieve a performance level less than the satisfactory performance level to decrease their base salary. It is contemplated that other compensation rules may be defined to apply to various situations, and the present invention is not limited to any specific compensation rule.

After the compensation rule has been provided at step 708, step 710 is performed to monitor the performance of an agent with respect to the performance metric (defined at step 702). Monitoring of an agent may be performed in any suitable way. As those with skill in the art will appreciate, the specific steps that are performed will depend on the metric being monitored. If the metric is defined as average call handling time, the step 710 is performed by monitoring the average call handling time of an agent. The monitoring of average call handling time may be performed by monitoring each individual call time and obtaining an average of each individual call time. In an alternative embodiment, the average call time may be calculated by monitoring the total call time and the total number of calls, and calculating the average call time by dividing the total call time by the total number of calls. As another example, if first call resolution is defined as a metric, step 710 may be performed by monitoring whether a customer who calls a first time must call a second time to resolve the problem.

The monitoring step 710 results in an agent performance metric. The agent performance metric represents the performance of an agent with respect to the defined metric. In some embodiments, the agent performance metric is defined as a quantifiable, objective value, e.g., average call time, number of calls handled, first call resolution, revenue etc. In other embodiments, the agent metric is represented as a numeric value, but may have a subjective component. For example, an agent's performance with respect to customer satisfaction may be rated using a numeric scale, e.g., a scale from one to five. As described below an agent's performance metric is used in step 712 to categorize/classify an agent's performance within one of the performance levels.

At step 712, the agent performance metric generated during the monitoring step 710 is compared to the threshold values to determine an agent performance level. The threshold values are used to determine which of the performance levels an agent's performance should be classified within. Generally, at step 712 an agent's performance metric is compared to the threshold values to determine which of the threshold values has been met. The agent's performance is then classified as falling within the performance level associated with the met threshold value. Expanding on a previous example for illustrative purposes, if an agent's average call time (agent performance metric) is below the threshold value associated with the “above satisfactory” performance level, then the agent's performance with respect to the metric, average call handling time, will be classified as “above satisfactory.”

Method 700 described above with respect to FIG. 7 is simply one method that implements PM business model 680. In other embodiments, method 700 may include more, or less, steps than those described above with respect to FIG. 7. For example in one embodiment, step 712 may be followed by an applying step which automatically applies the compensation rule based on the agent performance level to change the current compensation provided to the agent. Applying of the compensation rule may occur automatically without any input by a human supervisor. In other embodiments, the step 712 may be followed by an evaluating step. The evaluating step may be performed by a human supervisor to determine whether the compensation rule should be applied. In other embodiments, the evaluating step may be performed to determine whether/how a supervisor should provide coaching or other feedback to the agent.

As another example, method 700 may include additional steps such as communicating the compensation rule to the agent and providing access to performance information to the agent. The performance information may relate to, for example, the agent performance metric, threshold values, and agent performance level. In this embodiment, the additional steps tend to incentivize an agent, because they are aware of how their compensation is affected by their performance and have access to their performance information.

In other embodiments, step 712 may be followed by steps for changing the threshold values. In one specific embodiment, if an agent's compensation is changed as a result of their performance, the threshold values are adjusted to reflect the change in the agent's compensation. That is, if an agent gets an increase in their compensation (e.g., increase in base pay) the threshold values are changed so that an agent must perform at a higher level than before to achieve each of the performance levels. In some embodiments, if an agent receives a reduction in compensation, the threshold values are changed such that they are easier to achieve. In other embodiments, the threshold values may be changed based on the performance of a group of agents, such as a team or the entire organization. As one example, an average agent metric for a group of agents may be compared over a period of time (e.g., several months). If the comparison indicates that the agents' performance as a group is showing a trend, the threshold values may be changed as a result of the trend. The threshold values may be changed to require the agents to perform at a higher level, or they may be changed so that agents may more easily achieve performance levels.

It should be understood that the foregoing description of PM business model 680 and method 700 implementing PM business model 680 are for illustrative purposes only. The following description includes discussion of PM business model 680 as implemented using a computer-based approach. The present invention contemplates that in some embodiments the steps described above, made without reference to a computer-based approach, and the steps described below with respect to the computer-based approach may be combined in a variety of combinations, and may be implemented with or without the use of a computer system.

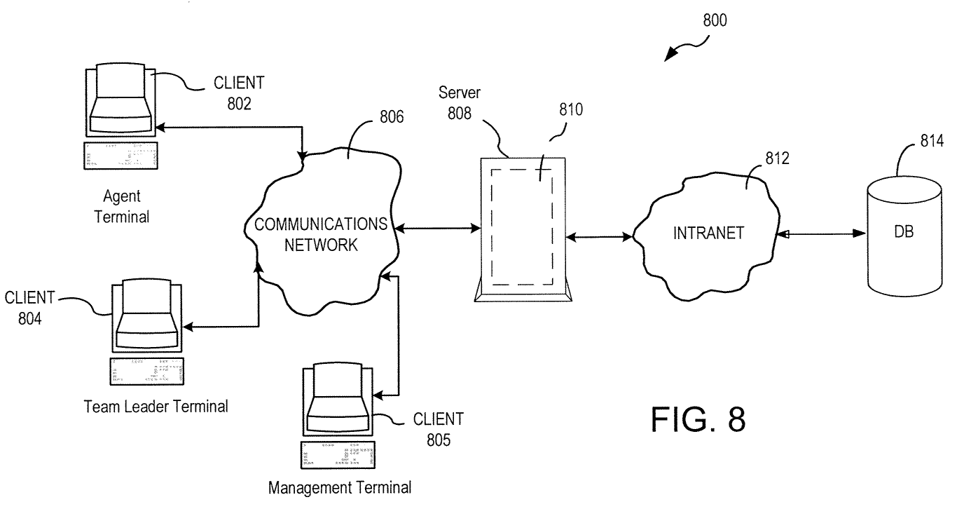

In accordance with an embodiment, the PM business model 680 described above is embodied within a software application 810 implemented in a distributed computing environment 800, as shown in block diagram form in FIG. 8. The distributed system 800 includes a plurality of client computers 702, 804 and 805, a communications network 806 (hereinafter, “network”), a server computer 808, an intranet 812 and a database 814. The performance management software application 810 resides on the server computer 808 and is accessible to any of the plurality of client computers 702, 804 and 805 by way of the communications network 806. In embodiments, the client computers 802, 804, and 805 are part of one or more client call centers 102 (FIG. 1), 104 (FIG. 1) or 106 (FIG. 1). The server computer 108 is, in embodiments, a component of the shared call center 100 (FIG. 1), such as the manpower scheduling component 148 (FIG. 1) or the enterprise reporting component 150 (FIG. 1). The intranet 812 can be the IP network 124 (FIG. 1) and the database 814 can be the database 146 (FIG. 1). The software application 810 may be activated, controlled and manipulated by users on the client computer 802, 804 and 805 at remote locations using conventional networking technologies. Furthermore, browser applications (not shown) are implemented on the client computer 802, 804 and 805 and used to render electronic resources (e.g., web pages) containing information related to performance management. For simplicity and clarity, the software application 810, which is described in detail below in connection with FIG. 8, is hereinafter referred to as a “performance management application 810.”

As depicted in FIG. 8, the distributed system 800 may be thought of as having two distinct components: “front-end” client computer 802, 804 and 805 and the “back-end” server computer 808 on which the performance management application 810 is implemented. In accordance with an embodiment of the present invention, the back-end server component 808 can be a personal computer, a minicomputer, or a mainframe that performs, among other functions: data managing, client information sharing, security services and administration functions related to the performance management application 810. A server farm (not shown) may alternatively be used. The distributed system 800 is not limited to any particular implementation and instead embodies any computing environment upon which functionality of the environment may be practiced.

While only three client computer 802, 804 and 805 are shown, it should be appreciated that the distributed system 800 may include any number of client computers. For example, in an embodiment, the communications network 806 may be the Internet or, alternatively, an Intranet, wherein the server computer 808 is a central server on which the performance management application 810 resides and is specifically identified to have a network location expressed as a Uniform Resource Locator, or URL. Accordingly, implementation of the performance management application 810 renders a web site or, alternatively, Intranet site, identified by the LRL and hereinafter referred to for nomenclature purposes as a “performance management website.” The client computer 802, 804 and 805 thus represent computers connected to the communications network 806 through any conventional means such as, for example, routers and switches. Accessing the performance management application 810 therefore involves a user (either an agent, team leader or management) activating a browser application (not shown) on a client computer 702 or 804 and directing the browser application to the URL specified for the performance management application 810. As shown in FIG. 8, agents access the performance management application 810 using the client computer 702; team leaders access the performance management application 810 using the client computer 804 and management access the performance management application 810 using the client computer 805.

When accessed by a user (e.g., agent, team leader or management, as described above) over the communications network 806, the performance management application 810 renders the aforementioned performance management website, which includes various forms of information and functionality related to performance management both from an individual standpoint and a collective (i.e., team-based and organization-based) standpoint. Based on website manipulation by the user, the performance management application 810 retrieves such information from the database 814 via the intranet 812 or, alternatively, from local cache memory, and provides that information to the user's browser for rendering therein.

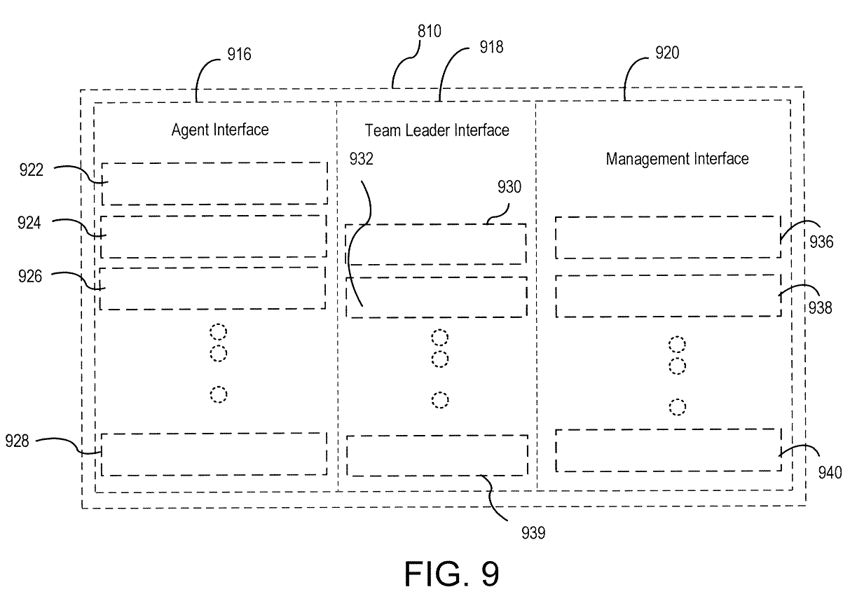

With reference now to FIG. 9, the performance management software 810 is described in more detail with reference to information and functionality provided by the software 810 in accordance with an embodiment of the present invention. Specifically, in accordance with this embodiment, the performance management software 810 is based on a tri-layer (916, 918 and 920) platform of software components that include an agent interface 916, a team leader interface 918 and management interface 920. The performance management software application 810 is referred to in commerce as “Empower™” and, similarly, the agent interface 916, the team leader interface 918 and the management interface 920 are referred to as “Empower¹,” “Empower²” and “Empower³,” respectively.

The performance management software application 810 provides specific interfaces 916, 918 and 920 and associated levels of access to users based on whether the users are agents, team leaders or management. Each interface 916, 918 and 920 embodies one or more electronic resources that provide information and/or functionality specifically intended and authorized for one of these specific types of users. When accessed by a user, an instance of the performance management website is created on the server computer 808 and one of these interfaces (916, 918 or 920) is activated to render electronic resources relevant for that user. For example, if the user is an agent, the agent interface 916 is activated to render electronic resources (e.g., web pages) specifically configured (in content and format) to that agent.

With specific reference to these interfaces 916, 918 and 920, the agent interface 916 provides agents with access to information concerning their specific performance relative to a certain time including an indication of how their performance affects, could affect (if maintained) and/or has affected their compensation. In an embodiment, performance is measured against a set of defined metrics and, as such, the agent interface 916 provides agents with an indication of how their performance ranks against the defined metrics during a given time period (e.g., day, week, month, year). This information may be presented in numerous different formats and, to accommodate the format in which the information is displayed, the agent interface includes user interface features, generally shown as 922, 924, 926 and 128, which provide agents with the ability to view the information in a variety of formats and details. Table 2 below illustrates an example of a graphical representation that may be displayed by interface 916 in some embodiments (in other embodiments Table 2 may be displayed by anyone of interfaces 916, 918, or 920). Table 2 illustrates a graphical representation that relates a performance level achieved by an agent to a time period, in this case a month over which the agent achieved the performance level. In other embodiments, the graphical representation may relate the performance level achieved by an agent to the day the agent achieved the performance level (e.g., a calendar with a graphic indicating an achieved level for each day of a month.). Also, in other embodiments, Table 2 may relate to a group of agents (i.e., a team) or an organization as a whole.

TABLE 2

| | January | February | March | April |
|---|---|---|---|---|
| Exceptional | | | | |
| Above Satisfactory | | | | |
| Satisfactory | | | | |
| Below Satisfactory | | | | |

In some embodiments, agent interface 916 provides for displaying a graphical representation of an agent's achieved metric relative to one or more threshold values. This allows the agent to easily determine how to change their behavior (e.g., spend less time on a call) so that they can achieve a desired threshold and therefore performance level. For example, agent interface 916 may display a graphical representation, such as a bar graph with four bars that represent threshold values. In this embodiment, the bar graph will also include one bar showing the agent's performance metric. This graphical representation allows a viewer (e.g., an agent or supervisor) to easily see, where the agent's metric is in relation to threshold values.

The team leader interface 918 allows each individual responsible for supervising tasks of a team of agents to access information concerning the performance of his or her group as a whole. As noted above, such performance is measured against a defined set of metrics in accordance with an embodiment. Additionally, the team leader interface 918 provides these individuals access to the agent interface 916 such that they are able to access performance information concerning each of the agents within their team. The team leaders are only authorized to use the agent interface 916 to view information concerning the agents associated with their team. In contrast, the management interface 920 is associated with unrestricted authorization to performance information and provides access to such information concerning each individual agent, each team of agents and, collectively, all agent teams as a whole. The management interface 920 therefore provides its authorized users with access to performance information for the entire company or organization as well as access to the agent interface 916 and the team leader interface in order to view performance data for agents and teams, respectively. In an embodiment, the present invention is practiced as a method for determining whether a user requesting access to the performance management software application 810 is an agent, a team leader or management and, based on the determined type of user, the method returns the appropriate interface 916, 918 or 920.

The graphical representations described above, and those further described below, are also useful in methods and processes that are not implemented using computer systems. As mentioned above, it is contemplated that in some embodiments the present invention will combine features, aspects, components, steps, and processes described herein with respect to the computer implemented methods, with those described above without the use of computer systems.

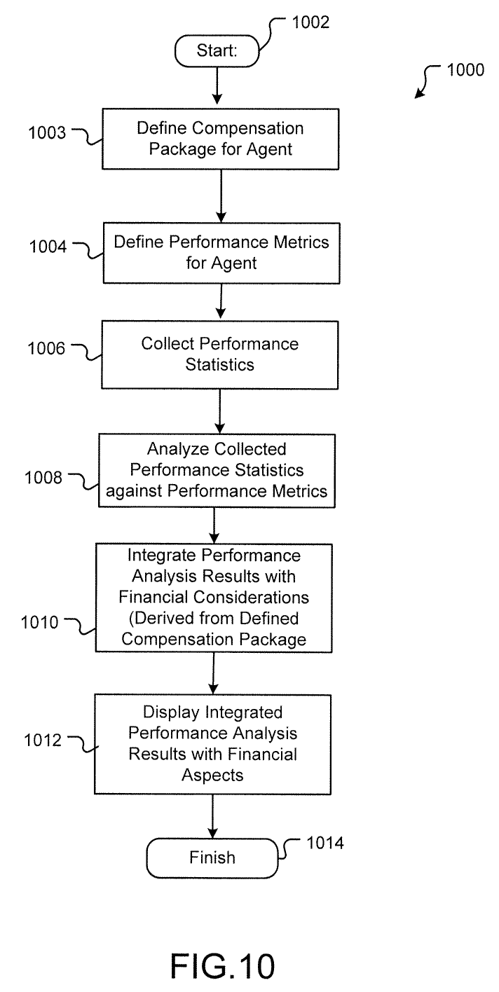

FIG. 10 describes a monitoring process 1000 for implementing the PM business model 680 in conjunction with the performance management software application 810 to provide users with a computer-based system for monitoring performance in accordance with an embodiment of the present invention. As such, the monitoring process 1000 is operable to evaluate an agent's, team's or entire organization's performance against relative criterion, or metrics, and link such evaluation to financial considerations, as described above. With that said, the monitoring process 1000 is described below with reference to only one agent for simplicity purposes; however, it should be appreciated that the process is preferably practiced in numerous instances for each agent in an organization. The monitoring process 1000 is performed using an operation flow that begins with a start operation 1002 and ends with a finish operation 1014. The start operation 1002 is initiated to begin monitoring performance of a specific agent in an organization. From the start operation 1002, the operation flow initially passes to a first define operation 1003.

The first define operation 1003 establishes the agent's compensation package, which may include, without limitation any of the following: base salary, actual or expected variable pay (e.g., bonuses, in-kind compensation, stock options, etc.) or any other compensation. In an embodiment, the first define operation 1003 associates the compensation package with one of a predetermined number of compensation groups, or “compensation buckets.” For example, these compensation buckets may include the following four different categories ranging from the relative lowest compensation packages of all agents to the relative highest compensation packages of all agents in the organization: group I, group II, group III, and group IV. After the agent's compensation package and associated bucket has been determined, the operation flow passes to a second define operation 1004.

The second define operation 1004 establishes one or more performance metrics for the agent. The performance metrics embody threshold performance statistics defined for the agent and may relate to any number of performance-based considerations such as, without limitation, call resolution statistics, customer satisfaction statistics, revenue statistics, attrition statistics, call reduction statistics and quality assessment statistics. In an embodiment, the threshold performance statistics are based on the compensation package determined for the agent. As such, two agents having the exact same responsibilities would have differing threshold performance statistics if paid differently. With that said, an embodiment of the present invention involves setting the agent's performance metrics based on the compensation bucket within which the agent's compensation package is categorized. After the one or more performance metrics have been defined for the agent, the operation flow passes to a collect operation 1006 as the agent begins working for the organization and accomplishing tasks.

The collect operation 1006 collects actual performance statistics associated with the accomplishment of tasks by the agent. For example, if the agent is a customer service agent, the collect operation 1006 may collect information embodying the number of calls that the agent disposes without the assistance of any other agents (i.e., first call resolution and call reduction). In an embodiment, the operation flow is maintained at the collect operation 1006 and performance statistics are collected until a request is made by an agent, his or her team leader or management to monitor performance of that agent or his/her team, at which time, the operation flow passes to an analysis operation 1008. Alternatively, the collect operation 1006 may perform statistics collection for a predetermined period of time (e.g., daily), the conclusion of which passes the operation flow to the analysis operation 1008.

Regardless of the implementation, the operation flow passes from the collect operation 1006 to the analysis operation 1008, which analyses the collected performance statistics against the threshold performance statistics to determine the relative extent to which the agent meets the performance metrics set by the define operation 1004. With that said, an embodiment of the present invention involves ranking the agent's performance against the metrics as a whole into one of four categories, or “performance buckets:” below satisfactory, satisfactory, above satisfactory and exceptional. After the agent's performance has been ranked and categorized into one of the four “performance buckets,” the operation flow passes to a merge operation 1010.

The merge operation 1010 integrates for analysis purposes the agent's performance with specified financial considerations, which may include any one or more of the following: the agent's base salary, the agent's variable pay (e.g., bonuses, in-kind compensation, stock options, etc.) or expected variable pay, a combination of both or the agent's entire compensation package, as defined in the first define operation 1003. For exemplary purposes, the monitoring process 1000 is described herein with the merge operation 1010 integrating the agent's performance with his or her compensation package. That is, the merge operation 1010 creates a representation in memory (e.g., on the server computer 808) of how the agent's performance compares with his or her compensation package for analysis as to the relative expected performance of the agent. From the merge operation 1010, the operation flow passes to a display operation 1012.

The display operation 1012 renders the integrated information created by the merge operation 1010 in a manner for display on a browser or other application of one of the client computer 802, 804 and 805. In an embodiment, such rendering involves creating and displaying a graphical representation comparing or otherwise relating the performance results to financial considerations specifically associated with the agent. Accordingly, the display operation 1012 displays the results of the agent's performance analysis (from the analysis operation 1008) in combination with these specific financial considerations. In an embodiment, as noted above, these financial considerations preferably embody the agent's compensation package. In accordance with this embodiment, the graphical representation embodying a table having columns representing the different compensation buckets and rows representing the different performance buckets, as shown below in an example in Table 1:

TABLE 1

| | Learning | Successful | Successful+ | Role Model |
|---|---|---|---|---|
| Exceptional | | | | |
| Above Satisfactory | | | | |
| Satisfactory | | | | |
| Below Satisfactory | | | | |

Such a table allows for the agent's performance results to be compared against his or her compensation package in a meaningful manner for review by the agent, his or her team leader or management. Indeed, while Table 1 is described as presenting performance versus financial information for only a single agent in order to illustrate the monitoring process 1000 of FIG. 10, embodiments of the present invention involve using such an integration presentation technique to display information for a collective set of agents (i.e., a “team) or the organization as a whole. With respect to the former, the display operation 1012 renders a graphical representation comparing or otherwise relating the performance results of an entire team of agents to financial considerations specifically associated with the team (e.g., the collective compensation package of the team). With respect to the latter, the display operation 1012 renders a graphical representation comparing or otherwise relating the performance results of an entire organization (e.g., a plurality of teams) to financial considerations specifically associated with the organization (e.g., the collective compensation package of the organization). Accordingly, Table 1 is applicable for display through not only the agent interface 916, but also the team leader interface 918 (to display performance versus financial information for individual agents and teams as a whole) and the management interface 920 (to display performance versus financial information for individual agents, individual teams and the organization as a whole). From the display operation 1012, the operation flow concludes at the terminate operation 1014.

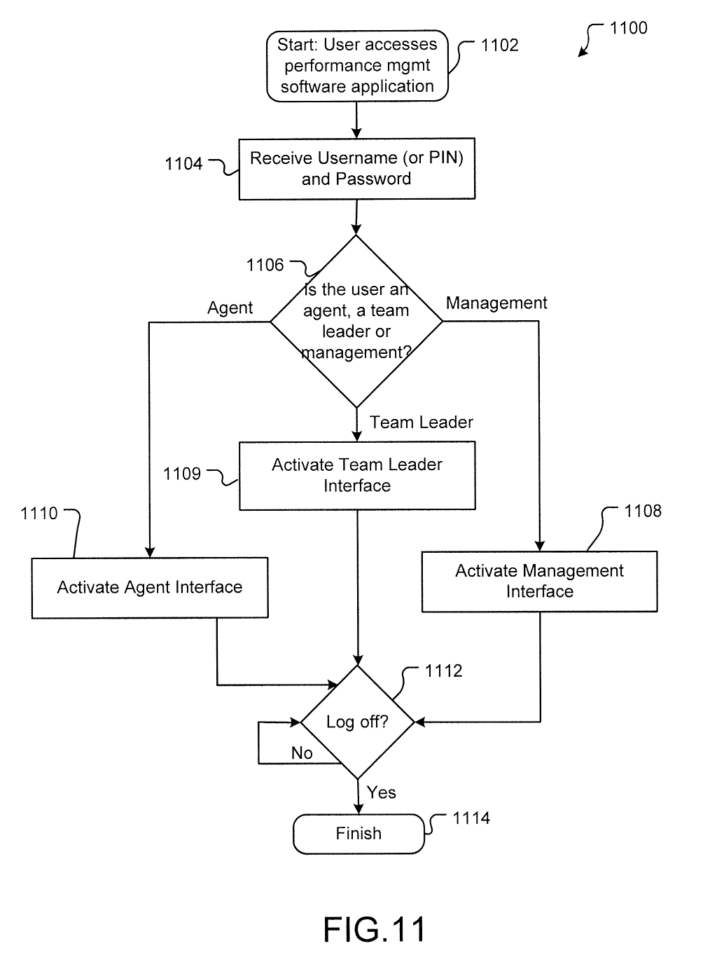

Turning now to FIG. 11, a process 1100 for rendering display of an appropriate interface (e.g., 916, 918 or 920) for a user of the performance management software 810 is shown in accordance with an embodiment of the present invention. The rendering process 8100, which embodies the display operation 1012 shown in FIG. 10, is described in an exemplary embodiment as being performed by the server computer 808 to render the performance management website on a browser application. For illustration purposes, the browser application is described herein as being implemented on one of the client computer 802, 804 and 805 communicatively connected to the server computer 808 via the network 806. However, in accordance with an alternative embodiment, the browser application may be implemented on a client computer or other user terminal locally connected to the server computer 808 by way of the intranet 812. Such an embodiment is particularly useful in circumstances wherein a team leader or management is accessing the performance management software 810 from client computer located on-site with the server computer 808 (e.g., an organization's campus). Regardless of implementation, the process 1100 is performed using an operation flow that begins with a start operation 1102 and ends with a finish operation 1114.

The start operation 1102 is initiated in response to a user requesting access to the performance management application 810 through one of the client computer 802, 804 or 805. Accordingly, the start operation 1102 is triggered in response to the user entering the URL of the performance management application 810 into the browser application, which then through conventional networking technology, directs the request to the server computer 808. In response, the performance management website is rendered in the browser application and available for use by the user. The performance management website provides access to the three different interfaces 916, 918 and 920, which, as described above, are each associated with a different level of authorized access based on user type (i.e., agent, team leader, management). That is, each agent is only authorized to access the agent interface 916 and, more particularly, only to their performance information. In contrast, team leaders are authorized to access team leader interface 918, which provides access to performance information associated with their team as well as performance information for all agents on their team. In an embodiment, the latter form of information (i.e., information specific to all agents that report to a team leader) is made available to team leaders by way of the agent interface 916, which is through the team leader interface 918. In further contrast, management for an organization is authorized to access management interface 920, which provides performance information associated with the organization as a whole as well as performance information for each individual team and agent. Again, to accomplish the latter, the team leader interface 918 and the agent interface 916 are both accessible to management through the management interface 920. Because of these different authorization levels, the initially-rendered webpage, or “homepage,” of the performance management web site includes a user interface region (i.e., “logon component”) in which authorized users, e.g., agents, team leaders and management, may enter a unique identification name (e.g., PIN) and a password to access their private and personalized specific information.

After the performance management website has been rendered in the user's browser application, the operation flow of the management process 1100 passes to a receive operation 1104. The receive operation 1104 is triggered in response to the user submitting a valid PIN and corresponding password to the performance management application 810 via the logon component. In receipt of such authorizing information, the operation flow passes to a first query operation 1106. The first query operation 1106 determines whether the user is an agent, a team leader or management. In an embodiment, such a determination involves consideration of the PIN, which either in memory of the server computer 808 or in the database 814, is linked to a designator of the user type assigned the PIN.

If the first query operation 1106 determines that the user is management, the operation flow is passed to a first activate operation 1108, which activates the management interface 920 to render web pages specifically intended for management, as described above. If the first query operation 1106 determines that the user is a team leader, the operation flow is passed to a second activate operation 1109, which activates the team leader interface 918 to render web pages specifically intended to relate to team leaders, as described above. If the first query operation 1106 determines that the user is an agent, the operation flow is passed to a third activate operation 1110, which activates the agent interface 916 to render web pages specifically intended to relate to agents, also as described above.

After the appropriate interface (916, 918 or 920) of the performance management application 810 has been activated, the operation flow passes to a second query operation 1112. The second query operation 1112 detects whether the user has logged off of the performance management website and, if so, passes the operation flow to the finish operation 1114, which terminates, or closes, the activated interface (916, 918 or 920). Otherwise, the operation flow is maintained at the second query operation 1112, which is continuously practiced until the user logs off of the performance management website.

Attention is now turned to FIGS. 8 and 9, which further illustrate combined implementation of the PM business model 680 and the performance management software application 810 in accordance with an embodiment of the present invention and, thus, further depict the unique combination of performance management and rewards with enabling technology provided by embodiments of the present invention. FIGS. 8 and 9 illustrate that the performance management software application 810 is designed to enable and automate the PM business model 680, the combination of which involves data acquisition and aggregation, administration, performance calculation, agent review, supervisor review and compensation adjustments, as described in more detail below.

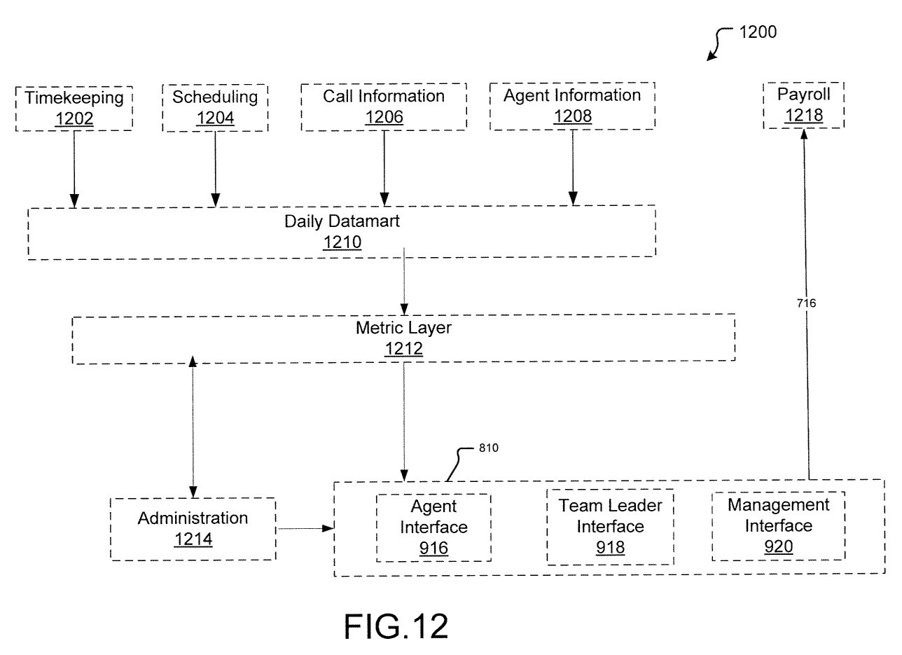

Shown in FIG. 12 is a block diagram of a software environment 1200 that implements PM business model 680 and the performance management software application 810, according to an embodiment of the present invention. Environment 1200 includes a number of applications 1202, 1204, 1206 and 1208, which collects or maintains information that is relevant to performance of an agent (explained in greater detail below). Additionally, a datamart application 1210 acquires and aggregates collected data from applications 1202, 1204, 1206, and 1208 on a daily basis. The collected data acquired by datamart application 1210 is used by a metric layer 1212 to calculate metrics. System 1200 also includes an administration application 1214 that is used to predefine the metrics calculated by metric layer 1212, and predefine performance/pay criteria, which may be referred to in commerce and herein as paysets, to evaluate agent performance. PM application 810 will use the metrics calculated by metrics layer 1212 and the predefined performance/pay criteria to evaluate agent performance and provide compensation adjustments 716 to payroll application 1218, if warranted.

In environment 1200, the applications 1202, 1204, 1206 and 1208 are intended to generally illustrate software applications that collect information that is relevant to evaluating the performance of an agent. Although described below specifically with respect to a customer service representative agent, in other embodiments, applications 1202, 1204, 1206, and 1208 will collect data that is relevant to the tasks performed by the specific agents whose performance is being managed. Moreover, although applications 1202, 1204, 1206 and 1208 are described as individual applications that may relate to several applications and/or include a number of different modules.

Application 1202 is a timekeeping software application that maintains the hours worked by individual agents. For example, an agent may use application 1202 to clock in when beginning work for the day, and clock out when the work day is over. Scheduling application 1204 may include information that indicates the particular schedule that an agent is assigned and expected to work, such as the day of the week with the specific hours of the day. Application 1206, in embodiments, is an application that maintains and generates information about specific calls that are handled by agents. Some examples of information that application 1206 collects include call times, number of calls handled, and quality assurance information for calls. In other embodiments, application 1208 may collect or maintain other data relevant to evaluating an agent's performance. Agent information may be maintained and generated by application 1110. Agent information may include for example identifying information for agents employed by an organization. As can be appreciated, applications 1202, 1204, 1206 and 1208 all collect or maintain information that is useful in evaluating an agent.

Daily datamart 1110 acquires, aggregates, and stores collected data from applications 1202, 1204, 1206 and 1208, on a daily basis. The data is merely received and aggregated from applications 1202, 1204, 1206 and 1208. Although as is appreciated by those with skill in the art, acquiring and aggregating data from applications 1202, 1204, 1206 and 1208 may involve a number of ETL (extract, transform, load) processes.

The administration application 1214 is used to predefine metrics that will be used to evaluate agents. As described above, some examples of metrics include call resolution, customer satisfaction, revenue generation, attrition, call reduction and quality assessment. Administration application 1214 is used to define the metrics as a function of the collected data acquired and aggregated in daily datamart 1210. For example, using administration application 1214, an average call handle time metric may be defined as a function of: total call time divided and total number of calls for an individual agent. This is merely one example, and any metric useful in evaluating an agent can be defined using administrative application 1214 as a function of the collected data.

The metrics layer 1212 uses the collected data to calculate agent metrics according to the predefined metrics. As described above, the metrics are predefined using administration application 1214. The metrics layer 1214 may include one or more applications that take as input the collected data from daily datamart 1210 and calculates agent metrics according to the metrics predefined using the administration application. The metrics layer 1214 provides the calculated metrics to the PM application 810.

Referring again to administrative application 1214, it is also used to establish paysets. A payset includes key performance indicators defined in terms of levels combined with metrics. In order for an agent to achieve a specific level, he/she must meet a threshold for a number of metrics. For example, in an embodiment, there may be four performance levels: below satisfactory, satisfactory, above satisfactory and exceptional. To be ranked within a performance level, an agent must meet thresholds for metrics defined for each level. For example, in one embodiment, average call handle time may be defined as a metric. In this embodiment, to achieve the exceptional level an agent must have an average handle time less than 330 seconds (threshold). While to meet the above satisfactory level, an agent may only need to have an average call time of less than 390 seconds (threshold). The thresholds are also defined in relation to an agent's compensation. If an agent's compensation is relatively higher than other agents, then the thresholds defined for the agent will also be relatively higher. That is, an agent compensated at a higher level must meet higher threshold values for every performance level. If an agent achieves a different level for one or more of the metrics, the agents overall performance will be ranked according to the lowest achieved level for any individual metric.

In addition to performance levels, a payset also defines base pay levels, which in one embodiment may include: learning, successful, successful+, and role model. The pay levels represent the monetary base pay for an agent. For example, in an embodiment, learning represents a lower base pay relative to successful, which represents a lower base pay relative to successful+. As described above, the pay level is used to define threshold values, and is also used in combination with the performance level to evaluate an agent's performance. The combination of performance level and pay level may be embodied in a table such as Table 1, described above. The paysets defined using administration application 1214 (the combination of pay level, performance level, and threshold values) are used to evaluate an agent and make adjustments to their compensation. For example, an agent with base pay at a learning pay level who achieves a role model performance level may be eligible for an increase in compensation. Paysets can be defined and applied to a site, client, program, job title, and/or call type.

PM application 810 uses the paysets defined using the administration application 1214, and the agent's metrics calculated and provided by the metrics layer 1212 to evaluate an agent's performance, determine compensation adjustments 1216, and provide access to an agent's performance using interfaces 916, 918, and 920. In one embodiment, the PM application 810 evaluates an agent's performance daily, including a performance evaluation for the day and updated cumulative monthly performances. As described above, the performance evaluations are accessed through interfaces 916, 918, and 920. Accordingly, PM application 810 allows real-time monitoring of an agent's performance on a daily basis.

As shown in FIG. 12, PM application 810 calculates compensation adjustments 1216 based on the defined paysets, and transmits the compensation adjustments 1216 to payroll application 1218, where they are implemented. As will be appreciated, in some embodiments the compensation adjustments 1216 may be calculated daily along with agents' performances, but only applied every pay period. Payroll application 1218 may be any conventional payroll application that is used to manage the payroll of an organization.

In some embodiments, the compensation adjustments calculated by PM application 810 are made and applied automatically, without any additional input by a manager. In this embodiment, a manager will, in addition to defining metrics and paysets, also define rules for providing compensation adjustments 1216. For example, using the previously discussed base pay levels and performance levels, a manager may establish a rule that whenever an agent performs at the role model performance level for 5 consecutive days, the agent will automatically receive a bonus (e.g., 2% of their base salary). In this example, when PM application calculates the performance levels for agents, it will automatically apply the rules established by the manager and provide compensation adjustments 1216 accordingly to payroll application 1218. In other embodiments, a manager may access PM application 810 using interface 918 or 920 and manually apply compensation adjustments 1216 based on viewing performance levels for agents. The compensation adjustments will then be provided to payroll application 1218.

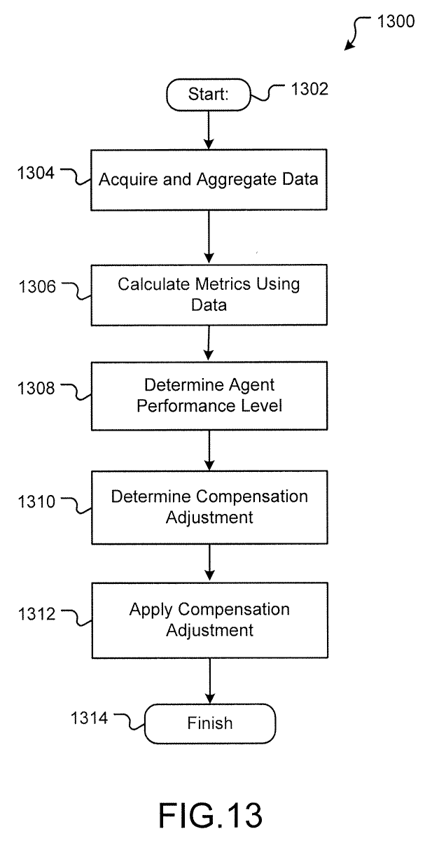

FIG. 13 illustrates a process 1300 for implementing the PM business model 680 for monitoring the performance of agents, and for generating compensation adjustments to modify compensation of agents based on their performance. As such, the process 1300 is operable to evaluate an agent's, team's or entire organization's performance against relative criterion, or metrics, and link such evaluation to financial considerations. The process 1300 is described below with reference to only one agent for simplicity purposes; however, it should be appreciated that the process is preferably practiced in numerous instances for each agent in an organization. The process 1300 is performed using an operation flow that begins with a start operation 1302 and ends with a finish operation 1314. The start operation 1302 is initiated to begin monitoring the performance of a specific agent in an organization. From the start operation 1302, the operation flow initially passes to acquire and aggregate data operation 1304.

The acquire and aggregate data operation 1304, collects data that is relevant to evaluating the performance of an agent with respect to an organization's strategic goals. The type of data that is acquired and aggregated during operation 1304 will depend on the tasks that an agent is performing for the organization. For example, if the agent is a customer service representative, then the data acquired and aggregated during operation 1304 may relate to data such as call handling time, quality assessment, number of hours worked, and number of calls handled. However, as will be appreciated, the data may relate to any data relevant to evaluating agents.

After the acquire and aggregate data operation 1304, the operation flow passes to calculate metrics 1306. The calculate metrics operation 1306 uses the data collected from operation 1304 to calculate agent's performance metrics. As described above, performance metrics may be predefined along with threshold values. In operation 1306, the data acquired during operation 1304 is used along with predefined metrics to calculate an agent's metrics, which are then compared to the threshold values to evaluate the performance of an agent (operation 1308 described below). For example, in one embodiment a metric may be defined as the average time it takes an agent to handle a call. In this embodiment, the calculate metrics operation 1306 uses the data for the number of calls handled by an agent and the total call time of an agent (acquired and aggregated at operation 1304) to calculate an average call time for an agent.

The agent's metrics calculated at operation 1306 are used in operation 1308 to determine/evaluate an agent's performance level. Operation 1308 involves comparing the agent metrics, to established threshold values, which are predefined in relation to performance levels and a compensation (e.g., base pay) level of the agent. For example, in an embodiment, there may be four performance levels: below satisfactory, satisfactory, above satisfactory and exceptional. To be ranked within a performance level, an agent's metrics must meet threshold values defined for each level. In one embodiment, average call handle time may be defined as a metric. In an embodiment, to achieve the exceptional level an agent must have an average handle time less than 330 seconds (threshold). In some embodiments, if an agent achieves a different level for one or more metrics, the agents overall performance will be ranked according to the lowest achieved level for any individual metric.

Process flow passes to operation 1310 where the performance level is used to determine compensation adjustments. The compensation adjustments may be determined using any method that uses the performance level from operation 1308. In one embodiment, the performance level is analyzed in combination with a compensation (e.g., base pay level) to determine the compensation adjustments for an agent. One implementation of this embodiment was discussed above with respect to Table 1. As described above, the performance level is evaluated relative to an agent's base pay level and determinations are made whether the agent's performance level warrants an increase or decrease in compensation. In one embodiment, operation 1310 may involve determining whether and agent's performance has remained at a predetermined level for a number of months. As one example, if an agent has maintained a relatively high level of performance for three months, (as determined by comparing the performance level to a current base pay level) the agent may warrant an increase in base pay. On the other hand, if an agent has maintained a relatively low level of performance for two months, (as determined by comparing the performance level to a current base pay level) the agent may warrant a decrease in base pay.

At operation 1312, the compensation adjustments determined from operation 1310 are applied. In some embodiments, the compensation adjustments involve variable pay such as bonuses. In other embodiments, the compensation adjustments may involve changes (increase or decrease) to base pay.

Further embodiments of the present invention are generally directed to monitoring interaction between individuals for future evaluation or documentation purposes. With that said, an exemplary embodiment involves monitoring interactions between a customer and an agent. The agent or customer service representative may be employed on behalf of a client or company to communicate with customers in any capacity involving any matter pertaining to the company. For example, the customer service representative may discuss sales, product support as well as service or product installation with a customer and these exemplary interactions may be the subject of monitoring in accordance with the present invention.

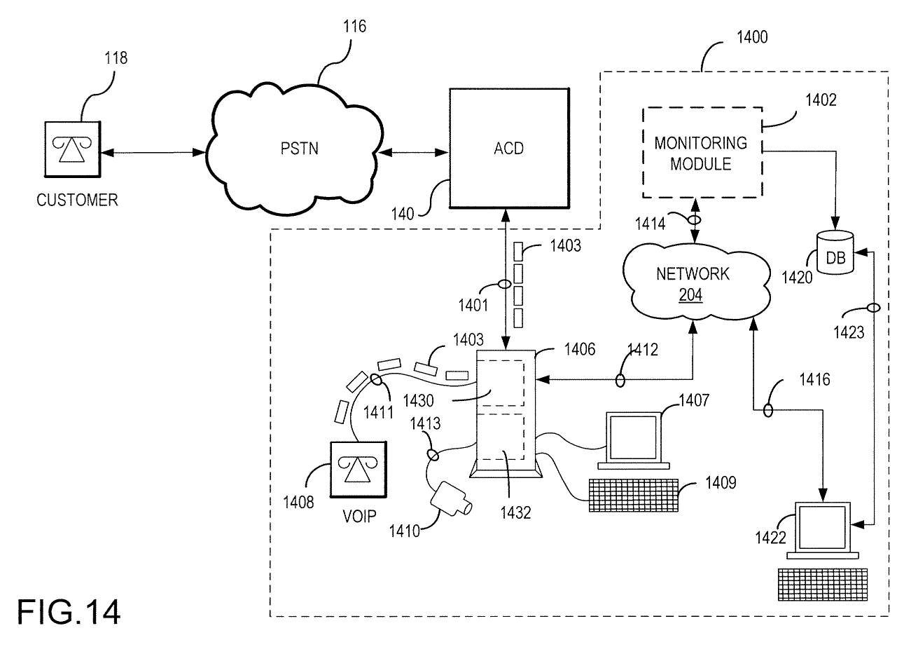

With the general environment in which embodiments of the present invention are applicable provided above, FIG. 14 depicts, in block diagram form, a system 1400 for monitoring (hereinafter, “monitoring system”) communication sessions between a customer and a customer service representative in accordance with an embodiment of the present invention. The monitoring system 1400 may be incorporated, either whole or in part, in the enterprise reporting component 150 (FIG. 1), the call management server 142 (FIG. 1), the manpower scheduling component 148 (FIG. 1), and/or the quality assurance component 144 (FIG. 1). The monitoring system 1400, in embodiments, includes a monitoring module 1402, a client computer 1406, such as agent terminal 128 (FIG. 1), which is assigned to each customer service representative and on which is implemented an interactive data recording application 1430 and an activity recording application 1432, a voice over Internet Protocol (VOIP) soft phone 1408 (optional) connected to each agent terminal 1406, a video capture device 1410 (optional) also connected (by video card) to each agent terminal 1406, an internal communication network 1404 (hereinafter, “intranet”), a database 1420, such as database 146 (FIG. 1), and a server computer 1422. For illustration purposes, the monitoring system 1400 is shown in FIG. 14 and described relative to monitoring only one customer service representative, however, it should be appreciated that numerous customer service representatives may be monitored and thus, any number of agent terminals 1406 (including interactive data recording applications 1430 and activity recording applications 1432), VOIP phones 1408 (optional) and video capture devices 1410 (optional) are contemplated to be part of the monitoring system 1400.

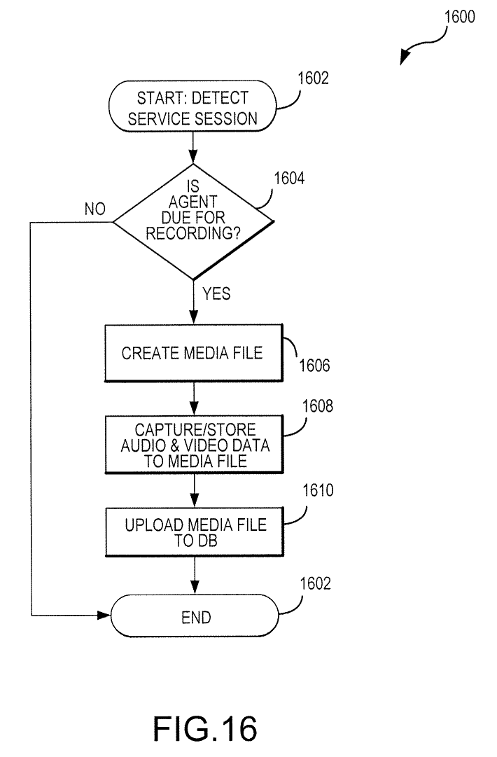

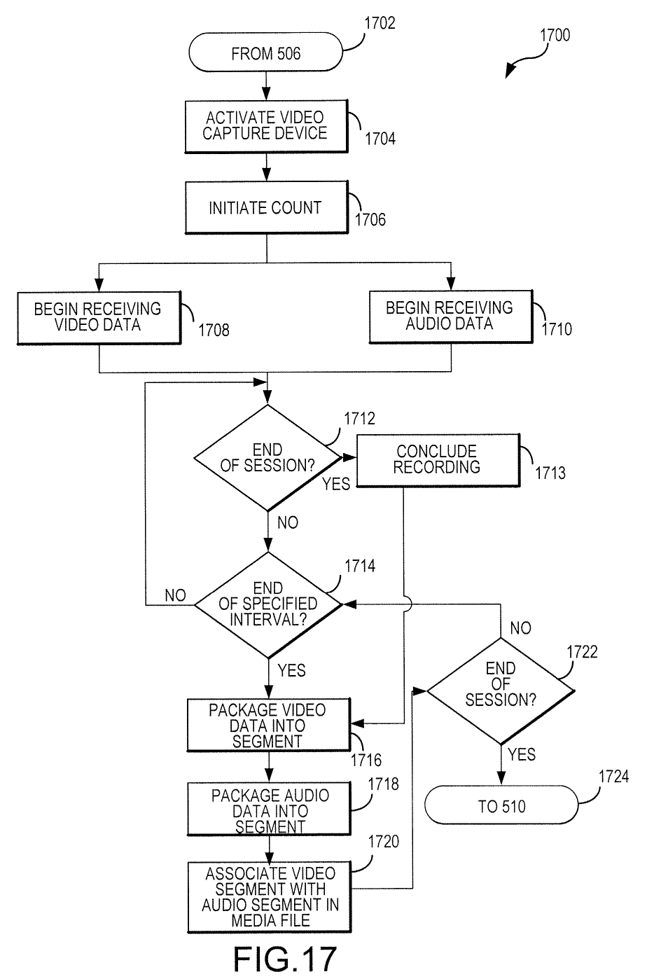

The monitoring module 1402 manages overall implementation of the system 1400 and, in accordance with an embodiment, is implemented as a software application residing in a computing environment, an exemplary depiction of which is shown in FIG. 4 and described below in conjunction therewith. With that said, the computing environment may be made up of the agent terminal 1406, the server computer 1422 and/or a central server computer (not shown), each of which are communicatively connected with one another by way of the intranet 1404. If the monitoring module 1402 is implemented on or otherwise accessible to more than one of these computing systems, the environment is coined a “distributed” computing environment. Because the monitoring module 1402 may be implemented on or otherwise accessible to any one or more of these computing systems, the monitoring module 1402 is shown in FIG. 14 in general form using a block and dashed lines. Indeed, the present invention is not limited to any particular implementation for the monitor module 1402 and instead embodies any computing environment upon which functionality of the monitoring module 1402, as described below and in conjunction with FIGS. 16 and 17, may be practiced.

The intranet 1404 may be any type of network conventionally known to those skilled in the art and is described in accordance with an exemplary embodiment to be a packet-switched network (e.g., an Internet Protocol (IP) network). As such, the monitoring module 1402, the agent terminal 1406 and the server computer 1422 are each operable to communicate with one another over the intranet 1404 according to one or more standard packet-based formats (e.g., H.323, IP, Ethernet, ATM).

Connectivity to the intranet 1404 by the agent terminal 1406, the monitoring module 1402 and the server computer 1422 is accomplished using wire-based communication media, as shown using data communication links 1412, 1414 and 1416, respectively. The data communication links 1412, 1414 and 1416 may additionally or alternatively embody wireless communication technology. It should be appreciated that the manner of implementation in this regard is a matter of choice and the present invention is not limited to one or the other, but rather, either wireless or wire-based technology may be employed alone or in combination with the other.

Each customer service representative is provided an agent terminal 1406 that is communicatively connected to an ACD 140 (FIG. 1) by a communication link 1401 (again, either wireless or wire-based) in accordance with an embodiment of the present invention. Alternatively, the ACD 140 (FIG. 1) may communicate with the agent terminal 1406 by way of the intranet 1404. In response to receiving an incoming call, the ACD 140 (FIG. 1) selects the appropriate customer service representative based on any number and type of considerations (e.g., availability, specialty, etc.) and connects the call to the corresponding agent terminal 1406.

In addition, the ACD 140 (FIG. 1) serves as a packet gateway, or “soft switch,” which converts the incoming Time Division Multiplexed (TDMA) signals from the PSTN 116 (FIG. 1) into a packet-based format according to one or more standards (e.g., H.323, IP, Ethernet, ATM), depending on the level of encapsulation desired within the monitoring system 1400. The audio information accepted from the PSTN 116 (FIG. 1) is therefore provided to the agent terminal 1406 in packets 1403 that may be interpreted by the agent terminal 1406, which as noted above is a computer system.

The VOIP phone 1408 and the video capture device 1410 (if utilized) are both communicatively connected to input/output ports (e.g., USB port, fire wire port, etc.) on the agent terminal 1406 by way of data communication lines 1411 and 1413. In an embodiment, the agent terminal 1406 is a desktop computer having a monitor 1407 and a keyboard 1409 in accordance with an exemplary embodiment, but alternatively may be a laptop computer. As noted above, the agent terminal 1406 includes two software applications for use in administering embodiments of the present invention—the interactive data recording application 1430 and the activity recording application 1432. The interactive data recording application 1430 records communications between customers and the customer service representative assigned to the agent terminal 1406. For example, the interactive data recording application 1430 records any voice data packets transmitted between the ACD 140 and the VOIP phone 1408. Additionally, the interactive data recording application 1430 may record any other audio information, email information or chat information embodying interaction between the customer and the customer service representative. The activity recording application 1432 records various forms of activity performed by the customer service representative assigned to the agent terminal 1406 during such customer interaction. For example, the activity recording application 1432 receives and records video data from the video capture device 1401 (by USB, serial or other connection) and, in an embodiment, also monitors other forms of information such as, for example, computer screen activities, mouse movements and keyboard actions.

Briefly describing functionality of the monitoring system 1400 relative to phone communications, after selecting a customer service representative to accept a service call, the ACD module 140 (FIG. 1) begins converting the audio information embodied in the service call to the packet-based format and streaming the resulting packets 1403 to the agent terminal 1406. Concurrently, the monitoring module 1402 detects incoming packets to the agent terminal 1406 and determines whether the selected customer service representative is due for recording. Various factors may go into such a determination and the present invention is not limited to any particular factors. Indeed, in some embodiments, each customer service representative is recorded on a periodic basis (e.g., every tenth service session), whereas in other embodiments, all sessions with one or more particular customer service representatives are recorded.

Regardless of the manner of implementation, if the monitoring module 1402 determines that the selected customer service representative is due for recording, then the monitoring module 1406 creates an empty media file for use in storing data recorded during the service session. In an embodiment, the blank, or “skeleton,” media file is created on the agent terminal 1406 and embodies a data structure that will store both the interactive data and the activity data recorded during the service session. In accordance with an exemplary embodiment, the interactive data is described in connection with this illustration as embodying the audio communication (e.g., voice data) between the customer and the selected customer service representative and, in an embodiment, is divided into a plurality of contiguous segments of a predetermined size (corresponding to predetermined length in time). The activity data includes information documenting activities of the customer service representative working at the monitored agent terminal 1406 during the customer service session. Such information includes, but is not limited to, screen activities, mouse movements, keyboard actions, video camera recordings and any other internal or external device activity. Like the interactive data, the activity data is also divided into a plurality of contiguous segments of the same predetermined size (corresponding to predetermined length in time) as the interactive data segments to provide for facilitated synchronization. A more detailed explanation of receiving and storing the interactive data and the activity data is provided below in conjunction with FIG. 17.

After the media file is created, the monitoring module 1402 begins copying the interactive data from both incoming (i.e., carrying customer voice data) and outgoing (i.e., carrying customer representative voice data) packets 1403 and storing the copied interactive data to the media file while, at substantially the same time, instructs the activity recording application 1432 to begin recording the customer service representative's activity, the output from which is also directed to the media file. To illustrate, an exemplary embodiment involves the activity recording application 1432 receiving and records video data from the video capture device 1410, wherein the video data documents movement and physical activity of the customer service representative during the recorded customer service session. After the interactive data has been copied from the packets 1403, the agent terminal 1406 outputs the packets 1403 to either the VOIP phone 1408 or to the ACD module 140 (FIG. 1), depending on whether the packet is an incoming packet or an outgoing packet.

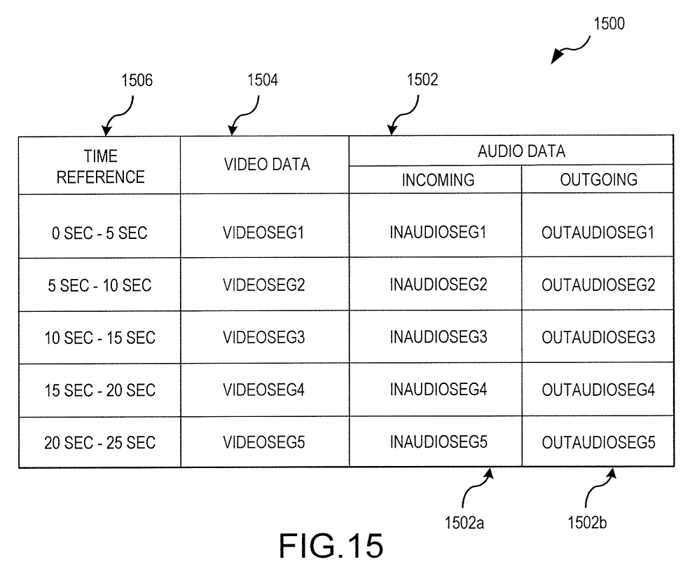

An exemplary representation 1500 of the relation between interactive data and activity data in a media file is shown in FIG. 15 in accordance with an embodiment of the present invention. Again, for illustration purposes only, the interactive data is described in the illustration of FIG. 15 as being audio data embodying voice communications between a customer and a customer service representative and the activity data is described as embodying video data from the video capture device 1410. As repeatedly mentioned above, other forms of interactive data and activity data are certainly contemplated to be within the scope of the present invention.

The representation 1500 shown in FIG. 15 illustrates that the media file is made up of a plurality of audio segments 1502, which in an embodiment are separately embodied in incoming audio sub-segments 1502a and outgoing audio sub-segments 1502b, and a plurality of video segments 1504, each of which are associated with one another by a time reference 1506. In accordance with this embodiment, these time associations (i.e., time references 1506) between the audio segments 1502 and the video segments 1504 are established by the monitoring module 1402 as the segments 1502 and 1504 are being received by the agent terminal 1406. Accordingly, the video segments 1504 and the audio segments 1502 are synchronized based on a common time reference, which in an exemplary embodiment, is a clock on the agent terminal 1406. Additionally, the monitoring module 1402 identifies each media file with a specific identifier that uniquely identifies both the customer service representative and the particular service session for which the file has been created. For example, the file name for the media file may be used to associate the media file with such a unique identification.

Media files are uploaded by the monitoring module 1402 from the agent terminals 1406 to the database 1420 for storage and subsequent access by the server computer 1422. The transfer of media files between agent terminals 1406 and the server computer 1422 is accomplished over the intranet 1404. In an embodiment, the monitoring module 1402 administers media file uploads to the database 1420 at the completion of each recorded service session. Alternatively, the monitoring module 1402 may perform media file uploads to the database 1420 at the conclusion of a plurality of specified time intervals. Even further, monitoring module 1402 may accomplish media file uploading to the database 1420 in real time such that the agent terminal 1406 administers the continuous transmission of the audio and the video data to the database 1420 during recorded service sessions.

The server computer 1422 is used by supervisors to monitor interaction between customer service representatives and customers by viewing recorded service sessions. The server computer is communicatively connected to the database 1420 by way of the intranet 1404. Alternatively, the server computer 1422 may be provided a direct communication link 1423 to the database 1420. Regardless of the means of connectivity, the server computer 1422 is operable for use by a supervisor to request a stored media file for playback.

In addition, a supervisor may use the server computer 1422 to monitor interaction between customer service representatives and customers in substantially real time fashion. In accordance with this embodiment, the media file (including the recorded and time-associated interactive data and activity data) is streamed from the agent terminal 1406 to a publishing point. Alternatively, in accordance with this embodiment, the interactive data and the activity data may be streamed to the publishing point from the agent terminal 1406 in the form of raw data. In this embodiment, the raw interactive data and raw activity data are first streamed to streamer component (a software module component of the monitoring module 1402) that performs the appropriate time association between the two forms of data thereby creating the media file for the session being recorded. Regardless of the implementation, the supervisor uses the server computer 1422 to subscribe to the publishing point and remotely monitor customer service sessions as they occur.

In an embodiment, the media files are identified and also categorized in the database 1420 based on one or all of the following: the customer service representative; the calendar date (and, optionally time) that the media file was created; DNIS; ANI; Start Time; and Stop Time. Accordingly, selection of the appropriate media file by the supervisor is a matter of selecting that file from a logically categorized group of files in the database 1420 (e.g., by way of GUI). It should be appreciated that any conventional database retrieval application may be utilized to provide a front-end selection service for retrieving media files from the database 1420 for playback on the server computer 1422. Indeed, it is contemplated that such functionality may be programmed into the monitoring module 1402.

Turning now to FIG. 16, a process 1600 for recording interaction between a customer service representative and a customer is shown in accordance with an embodiment of the present invention. The recording process 1600 embodies a sequence of computer-implemented operations practiced by a combination of components in the monitoring system 1400, including the interactive data recording application 1430, the activity recording application 1432 and the monitoring module 1402, the latter of which is implemented on either a stand-alone computer system, e.g., the agent terminal 1406, the server computer 1422 or a central server computer (not shown), or a distributed computing environment that includes one or more of these stand-alone systems interconnected with one another by way of the intranet 1404.

Furthermore, although only a single agent terminal 1406 is shown in FIG. 14 for simplicity, it should be appreciated and understood that the monitoring system 1400 is applicable to monitor numerous customer service representatives and, therefore, any number of agent terminals 1406 are contemplated within the scope of the present invention. The monitoring module 1402 may therefore be implemented in whole or in part on each of these numerous agent terminals 1406 (or, alternatively, on a central server computer as noted above). Regardless of the actual environment on which the monitoring module 1402 is implemented, the recording process 1600, unlike the system description above, is described below with reference to a multiplicity of agent terminals 1406.

Consistent with the exemplary illustrations described in connection with FIGS. 14 and 15, the recording process 1600 is described below with reference to recording interactive data embodying voice communications between the customer and the customer service representative assigned to the user terminal 1406. Likewise, the activity data is described in connection with this illustration as being video data embodying movements and physical activities by the customer service representative during the customer service session being recorded. It should be appreciated that other forms of interactive data, e.g., email and chat information, and activity data, e.g., computer screen activity, mouse actions and keyboard actions, are certainly contemplated to be within the scope of the present invention.

The recording process 1600 is performed using an operation flow that begins with a start operation 1602 and concludes with a finish operation 1612. The operation flow of the recording process 1600 is initiated in response to the ACD module 140 directing a customer's service call to a specific customer service representative, at which time the start operation 1602 passes the operation flow to a query operation 1604. In an embodiment, the start operation 1602 detects that a specific customer service representative has been selected for a service session by detecting and examining identification and/or signaling data (e.g., G.729 information) embodied in a first packet 1403 of the service call received at the associated agent terminal 1406.

The query operation 1604 determines whether the selected customer service representative is due for recording. In an embodiment, customer service representatives are recorded on a periodic basis defined by a specified interval. The interval may be a time interval or an interval based on the number of service sessions since the last recorded service session for a particular customer service representative. In this embodiment, the query operation 1604 determines the last time that the selected customer service representative has been recorded and, if this recording was not made within the specified interval, then the query operation 1604 identifies the selected customer service representative as being due for recording.

In another embodiment, customer service representatives may be recorded pursuant to a request from a supervisor, and in this embodiment, the query operation 1604 determines whether such a request has been made. For example, requests to record a specific customer service representative may be entered into the monitoring module 1402 by way of the server computer 1422. Therefore, when selected for a service call, the query operation 1604 identifies the selected customer service representative as being due for recording. In yet another embodiment, all service calls directed to one or more of the customer service representatives may be scheduled for recording, and in this embodiment, the query operation 1604 recognizes the selected customer service representative as one of the representatives that are due for permanent recording and identifies him/her as such. Regardless of the embodiment employed, if the selected customer service representative is due for recording, the operation flow is passed to a create operation 1606. Otherwise, the operation flow concludes at the finish operation 1612.

The create operation 1606 creates an empty, or “skeleton,” media file for storing the interactive data and the activity data recorded during the instant service session. As described above with reference to the system environment, the media file is a data structure that will embody both the audio recordings (i.e., interactive data) and the video recordings (i.e., activity data) of the service session between the selected customer service representative and the customer. As described herein for illustrative purposes, the create operation 1606 involves creating and storing the media file in the memory of the agent terminal 1406 until such time that the media file is uploaded to the database 1420. In an alternative embodiment, however, the media file may be created in the database 1420 and, as the interactive data and the activity data is received into the agent terminal 1406, both forms of data are synchronized with one another and streamed in substantially real time to the database 1420. After the empty media file has been created, the operation flow passes to a data capture operation 1608.

The data capture operation 1608 captures the activity data recorded by the video capture device 1410 and the interactive data carried in the payload of the packets 1403 that are incoming and outgoing to the agent terminal 1406 assigned to the selected customer service representative. The data capture operation 1608 also stores both the interactive data and the activity data to the media file in synchronized fashion such that each segment of interactive data is associated by time reference with a segment of activity data, as illustratively shown in FIG. 15. The data capture operation 1608 is described in greater detail in FIG. 17 in accordance with an exemplary embodiment of the present invention. At the conclusion of the service session, the data capture operation 1608 passes the operation flow to an upload operation 1610.

In accordance with an embodiment, the upload operation 1610 maintains the media file on the agent terminal 1406 until the specified time for uploading to the database 1420. As described above with reference to the system environment, such timing may be specified to take place at the conclusion of each recorded service session or, alternatively, after every specified number of recorded service sessions. At the specified time, the upload operation 1610 uploads the media file to the database 1420 for storage and subsequent access by the server computer 1422. From the upload operation 1610, the operation flow concludes at the finish operation 1612.

Turning now to FIG. 17, the data capture operation 1608 is described in more detail in accordance with an embodiment of the present invention. Specifically, FIG. 17 illustrates a collection of operational characteristics embodying a process 1700 for storing interactive data and activity data captured during a service session to a media file. As with FIG. 16, the storage process is described with reference to the interactive data being voice communications (contained in packets) and the activity data is described with reference to the activity data being video data (captured by the video capture device 1410) in accordance with an exemplary embodiment of the present invention. The storage process 1700 is initiated at the conclusion of the create operation 1606 and is practiced using an operation flow that starts with a transfer operation 1702. The transfer operation 1702 transfers the operation flow of the recording process 1600 to the operation flow of the storage process 1700. From the transfer operation 1702, the operation flow initially proceeds to an activate operation 1704.

The activate operation 1704 activates the video capture device 1410 communicatively connected to the agent terminal 1406 assigned to the selected customer service representative, thereby initiating video recording of the service session. From the activate operation 1704, the operation flow passes to a count operation 1706. The count operation 1706 selects an initial time reference for the service session (e.g., 0 seconds) and initiates a counting procedure to measure the amount of time elapsed during recording of the service session.

With the counting initiated, the operation flow passes in substantially concurrent fashion to a video receive operation 1708 and an audio receive operation 1710. The video receive operation 1708 begins receiving the video data captured by the video capture device 1410 and storing the received video data to memory on the agent terminal 1406. Likewise, the audio receive operation 1710 begins copying the audio data from the payloads of incoming and outgoing packets 1403 and storing the received audio data to memory on the agent terminal 1406. With the reception of both forms of data still being accomplished, the operation flow passes (again, in substantially concurrent fashion) from the video receive operation 1708 and the audio receive operation 1710 to a first query operation 1712.

The first query operation 1712 determines whether the service session being recorded is complete. Such a determination may be made by analyzing signaling information embodied in the packets 1403 to detect an “end of call” designation or other like indicia. If the service session is complete, the operation flow passes to conclude operation 613, which, in a general sense, halts both the receive operation 1708 and the audio receive operation 1710. To accomplish this, the conclude operation 613 de-activates the video capture device 1410 and concludes the discovery of audio data within any incoming or outgoing packets (though, at the conclusion of the session, it should be understood that few to no packets 1403 will be transmitted to or from agent terminal 1406 to the ACD module 140). From the conclude operation 613, the operation flow passes to a video package operation 1716, which is described below. If, however, the service session is not complete, the operation flow passes from the first query operation 1712 to a second query operation 1714.

The second query operation 1714 determines whether the count from the initial time reference (with respect to the first iteration) or the conclusion of the previous time interval (with respect to the subsequent iterations) has reached a specified interval that corresponds to the predetermined size specified for the video and audio segments. If the specified interval has not been reached, the operation flow passes back to the first query operation 1712 and continues in a loop between the first query operation 1712 and the second query operation 1714 until either (1) the session is ended; or (2) the end of the specified interval has been reached. At the end of the specified interval, the operation flow is passed from the second query operation 1714 to the video package operation 1716. Again, the reception of video and audio data initiated by the video receive operation 1708 and the audio receive operation 1710 is maintained even with the operation flow passing away from the second query operation 1714.

The video package operation 1716 retrieves the video data that has been received and stored in memory of the agent terminal 1406 since the initiation of the counting (with respect to the first iteration) or the previous time interval (with respect to subsequent iterations) and packages the video data into a segment of predetermined size, as described above. From the video package operation 1716, the operation flow passes to an audio package operation 1718. Similarly, the audio package operation 1718 retrieves the audio data that has been received and stored in memory of the agent terminal 1406 since the initiation of the counting (with respect to the first iteration) or the previous time interval (with respect to subsequent iterations) and packages the audio data into a segment of the same predetermined size.

It should be appreciated that the order of operation of the video package operation 1716 and the audio package operation 1718 is illustrative only and, that in accordance with other embodiments, the order of operation may be reversed or performed substantially simultaneously. Regardless of the implementation, after both audio data and the received video data have been segmented, the operation flow passes to a synchronize operation 1720.

The synchronize operation 1720 saves the audio segment created by the audio package operation 1718 and the video segment created by the video package operation 1716 to the media file created by the create operation 1606 in association with one another according to a common time reference, as illustrated in the representation 1500 shown in FIG. 15 in accordance with an exemplary embodiment. Saved in this manner, playback of the audio segment will be synchronized with playback of the video segment. From the synchronize operation 1720, the operation flow passes to a third query operation 1722, which determines whether the first query operation 1712 determined the session to be complete or incomplete. It should be appreciated that the third query 1722 does not determine whether the session is complete or incomplete by itself, but rather relies on the decision by the first query operation 1712 due to the maintenance of reception of audio and video data during the package operations 1716, 1718 and the synchronize operation 1720 (if the first query operation 1712 indeed determined the session to not be complete).

If the first operation 1712 determined the service session to be complete, the third query operation 1722 passes the operation flow to a second transfer operation 1724. The second transfer operation 1724 transfers the operation flow back to the recording process 1600, which resumes at the upload operation 1610. Otherwise, the operation flow passes from the third query operation 1722 back to the second query operation 1714 and the storage process 1700 continues to further store (and synchronize) audio data and video data to the media file, as previously described.

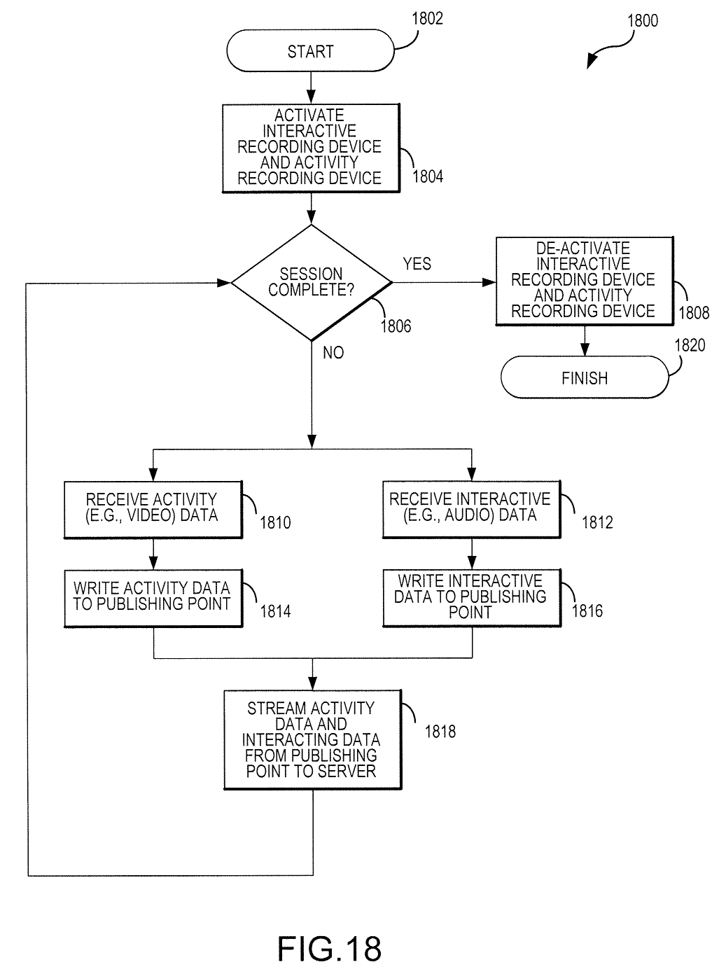

Turning now to FIG. 18, a process 1800 for monitoring interaction between a customer and a customer service representative in substantially real time is shown in accordance with an embodiment of the present invention. With reference to FIG. 14, this embodiment involves a user (e.g., supervisor) operating the server computer 1422 to monitor a customer service session as the session occurs. The monitoring operation is initiated with a start operation 1802 and concludes with a terminate operation 1820. Again, consistent with the exemplary descriptions above, the monitoring process 1800 is described herein with reference to the monitoring system 1400 shown in FIG. 14 as well as the exemplary embodiment in which the recorded interactive data embodies audio data exchanged between the customer and the customer service representative during the session and the recorded activity data embodies video data documenting physical movements and actions by the representative during the session.

The start operation 1802 is initiated in response to the agent terminal 1406 being selected for recording, at which time the operation flow passes to an initiate operation 1804. The initiate operation 1804 activates the interactive recording device 1430 for capturing the audio communications between the customer and the customer service representative and the activity recording device 1432 for capturing the video data from the video capture device 1410. From the initiate operation 1804, the operation flow passes to a query operation 1806. The query operation 1806 determines whether the session is complete and, if so, passes the operation flow to a de-activate operation 1808, which de-activates the interactive recording device 1430 and the activity recording device 1432. The operation flow then concludes at the terminate operation 1820.

If, however, the query operation 1806 determines that the session is not complete, the operation flow is passed substantially simultaneously to an activity data receive operation 1810 and an interactive data receive operation 1812. The activity receive operation 1810 captures the video data recorded by the video capture device 1410 and the interactive data receive operation 1812 captures the audio data carried in the payload of the packets 1403 that are incoming and outgoing to/from the agent terminal 1406. From the activity data receive operation 1810 and the interactive data receive operation 1812, the operation flow substantially simultaneously passes to an activity data transmit operation 1814 and an interactive data transmit operation 1816, respectively.

The activity data transmit operation 1814 writes the received video data to a publishing point, which in an embodiment is a software module or component of the monitoring module 1402 that may be subscribed by a user of the server computer 1422 to monitor sessions in real time. Likewise, the interactive data transmit operation 1816 writes the received audio data to the publishing point. From both the activity data transmit operation 1814 and the interactive data transmit operation 1816, the operation flow passes substantially simultaneously to a stream operation 1818, which streams the published video data and audio data to the server computer 1422, which is operated by a user (e.g., supervisor) to monitor the session in real time. From the stream operation 1818, the operation flow passes back to the query operation 1806 and continues as previously described.

Having described the embodiments of the present invention with reference to the figures above, it should be appreciated that numerous modifications may be made to the present invention that will readily suggest themselves to those skilled in the art and which are encompassed in the spirit of the invention disclosed and as defined in the appended claims. Indeed, while a presently preferred embodiment has been described for purposes of this disclosure, various changes and modifications may be made which are well within the scope of the present invention.

For example, while a VOIP soft phone 1408 is described for use with the monitoring system 1400, it should be appreciated that other types of phones may be utilized. In which case, the agent terminal 1406, while still using the packets 1403 for the purposes noted above, would convert the packets 1403 to the proper format (e.g., digital, analog etc.) for interpretation by such an alternative phone type.

Furthermore, while the PSTN 116 (FIG. 1) is shown in FIG. 14 and described in conjunction therewith in accordance with an exemplary environment of the present invention, it should be appreciated that alternative communication networks may be employed between the ACD module 140 (FIG. 1) and the customer's telephone 1402. For example, if the PSTN 116 (FIG. 1) may be replaced or supplemented with a packet-switched network, if so, the ACD module 140 (FIG. 1) may be relieved of the task of converting call information to the packet-based format, as described in conjunction with FIG. 14.

Additionally, while the various forms of recorded interactive data and recorded activity data are described herein as being stored together (with associated time references) in the same media file, an alternative embodiment involves these two forms of recorded data being stored in separate files while still being associated based on common time reference. For example, the audio data segments 1502 shown in FIG. 15 may actually reside in a separate media file than the video data segments 1504. However, the representation 1500 of FIG. 15 still applies in that each of the audio data segments 1504 (and, thus sub-segments) are associated with a video data segment 1504 based on a common time reference 1506. Indeed, the location of the physical storage of the individual segments 1502 and 1504 is irrelevant in accordance with this embodiment so long as each audio segment 1502 is associated with a video segment 1504 using a common time reference 1506.

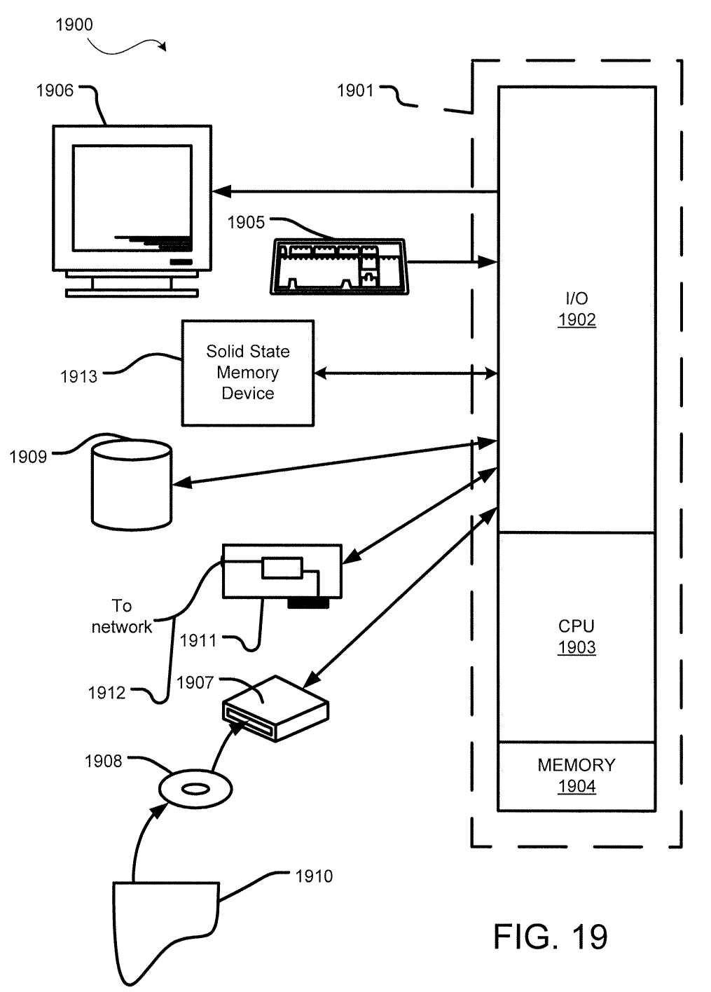

An exemplary operating environment on which the shared call center 100 is at least partially implemented encompasses a computing system 1900, which is generally shown in FIG. 19. Data and program files are input to the computing system 1900, which reads the files and executes the programs therein. Exemplary elements of a computing system 1900 are shown in FIG. 19 wherein the processor 1901 includes an input/output (I/O) section 1902, a microprocessor, or Central Processing Unit (CPU) 1903, and a memory section 1904. The present invention is optionally implemented in this embodiment in software or firmware modules loaded in memory 1904 and/or stored on a solid state, non-volatile memory device 1913, a configured CD-ROM 1908 or a disk storage unit 1909.

The I/O section 1902 is connected to a user input module 1905, a display unit 1906, etc., and one or more program storage devices, such as, without limitation, the solid state, non-volatile memory device 1913, the disk storage unit 1909, and the disk drive unit 1907. The solid state, non-volatile memory device 1913 is an embedded memory device for storing instructions and commands in a form readable by the CPU 1903. In accordance with various embodiments, the solid state, non-volatile memory device 1913 may be Read-Only Memory (ROM), an Erasable Programmable ROM (EPROM), Electrically-Erasable Programmable ROM (EEPROM), a Flash Memory or a Programmable ROM, or any other form of solid state, non-volatile memory. In accordance with this embodiment, the disk drive unit 1907 may be a CD-ROM driver unit capable of reading the CD-ROM medium 1908, which typically contains programs 1910 and data. Alternatively, the disk drive unit 1907 may be replaced or supplemented by a floppy drive unit, a tape drive unit, or other storage medium drive unit. Computer readable media containing mechanisms (e.g., instructions, modules) to effectuate the systems and methods in accordance with the present invention may reside in the memory section 1904, the solid state, non-volatile memory device 1913, the disk storage unit 1909 or the CD-ROM medium 1908. Further, the computer readable media may be embodied in electrical signals representing data bits causing a transformation or reduction of the electrical signal representation, and the maintenance of data bits at memory locations in the memory 1904, the solid state, non-volatile memory device 1913, the configured CD-ROM 1908 or the storage unit 1909 to thereby reconfigure or otherwise alter the operation of the computing system 1900, as well as other processing signals. The memory locations where data bits are maintained are physical locations that have particular electrical, magnetic, or optical properties corresponding to the data bits.

In accordance with a computer readable medium embodiment of the present invention, software instructions stored on the solid state, non-volatile memory device 1913, the disk storage unit 1909, or the CD-ROM 1908 are executed by the CPU 1903. In this embodiment, these instructions may be directed toward administering application of a shared call center 100. Data used in the analysis of such applications may be stored in memory section 1904, or on the solid state, non-volatile memory device 1913, the disk storage unit 1909, the disk drive unit 1907 or other storage medium units coupled to the system 1900.

In accordance with one embodiment, the computing system 1900 further comprises an operating system and one or more application programs. Such an embodiment is familiar to those of ordinary skill in the art. The operating system comprises a set of programs that control operations of the computing system 1900 and allocation of resources. The set of programs, inclusive of certain utility programs, also provide a graphical user interface to the user. An application program is software that runs on top of the operating system software and uses computer resources made available through the operating system to perform application specific tasks desired by the user. The operating system is operable to multitask, i.e., execute computing tasks in multiple threads, and thus may be any of the following: any of Microsoft Corporation's “WINDOWS” operating systems, IBM's OS/2 WARP, Apple's MACINTOSH OSX operating system, Linux, UNIX, etc.

In accordance with yet another embodiment, the processor 1901 connects to the intranet 124 (FIG. 1) by way of a network interface, such as the network adapter 1911 shown in FIG. 19. Through this network connection, the processor 1901 is operable to transmit within the shared call center 100, as described, for example, in connection with the agent terminal 128 transmitting media files to the database 146.

With the computing environment of FIG. 19 in mind, logical operations of the various exemplary embodiments described herein may be implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations making up the embodiments of the exemplary embodiments described herein are referred to variously as operations, structural devices, acts or modules. It will be recognized by one skilled in the art that these operations, structural devices, acts and modules may be implemented in software, in firmware, in special purpose digital logic, and/or any combination thereof without deviating from the spirit and scope of the present disclosure as recited within the claims attached hereto.

Numerous modifications and variations of the present invention are possible in light of the above teachings. It is therefore to be understood that within the scope of the appended claims, the invention may be practiced otherwise than as specifically described herein.

What is claimed is:

1. A system for serving a plurality of client call centers comprising:
shared call center infrastructure having a respective data connection to each client call center, the shared call center infrastructure comprising:
an automatic call distribution function for providing automatic call distribution upon incoming customer calls on behalf of the plurality of client call centers;
a monitoring system for monitoring interaction between individuals engaged in communication sessions embodied in interactive data transmitted between the individuals by way of a communication network, the system comprising:
a client communication device operable for use by a first individual to participate in the communication sessions;
a monitoring module operable to select for recording communication sessions to which the first individual has been selected for participation;
an client computer communicatively connected to the communication network and the client communication device such that the client computer receives any interactive data transmitted therebetween, wherein the client computer comprises an activity recording device operable to record actions made by the first individual during the communication sessions; and
a media file comprising interactive data copied by the client computer during a selected communication session and activity data recorded by the activity recording device during the selected communication session, wherein the interactive data and the activity data are synchronized in the media file according to a common time reference.

2. The system as defined in claim 1, wherein the shared call center automatic call distribution function comprises a media gateway and a automatic call distribution system.

3. The system as defined in claim 1, wherein the shared call center infrastructure comprises:
a media gateway adapted to convert between media format of incoming customer calls and a packetized format used in the shared call center infrastructure.

4. The system as defined in claim 3 adapted to convert all customer calls to a packetized format and to route each call to an appropriate client call center over the appropriate data connection.

5. The system as defined in claim 1, for serving the plurality of client call centers, at least one client call center having an associated client data center, wherein:
the shared call center infrastructure has a further data connection to each said associated client data center, the call center being further adapted to provide each client call center access to the associated client data center via the data connections to the client call centers and the data connections to the associated client data centers.

6. The system as defined in claim 1, in combination with at least one of the plurality of client call centers.

7. The system as defined in claim 1, wherein each client call center is located remotely from the shared call center infrastructure.

8. The system as defined in claim 1, wherein the shared call center infrastructure further comprises:
a call management server.

9. The system as defined in claim 1, wherein the shared call center infrastructure further comprises:
a quality assurance functional block.

10. The system as defined in claim 1, wherein the shared call center infrastructure further comprises:
a database server.

11. The system as defined in claim 1, wherein the shared call center infrastructure further comprises:
a manpower scheduling function adapted for shared use by operators of the plurality of client call centers.

12. The system as defined in claim 1, wherein the shared call center infrastructure further comprises:
an enterprise reporting system adapted to aggregate data from multiple systems for at least one client call center.

13. The system as defined in claim 1, wherein the shared network infrastructure further comprises:
a connection to the public Internet; and
a firewall for protecting the connection to the public Internet, the firewall providing protection both for the shared call center infrastructure, and for accesses of the public Internet by the client call centers.

14. The system as defined in claim 1, wherein all communications to the client call centers are behind at least one firewall thereby mitigating the need for a firewall in each client call center.

15. The system as defined in claim 1, wherein the data connections are VPN (virtual private network) connections.

16. A method for customizing a shared call center for one or more client call centers, the method comprising:
providing a shared call center infrastructure;
providing automatic call distribution functions to a plurality of remotely located call centers;
maintaining in the shared call center infrastructure a library of executable code modules, wherein each executable code module represents one or more user interface controls;
maintaining in the shared call center infrastructure a web-based visual development environment operable to access the library to retrieve therefrom the executable code modules maintained in the library;
receiving a request from a client computer to render the web-based visual development environment thereon to create the user interface for the web-based software application;
rendering the web-based development environment on the client computer such that identifiers of the one or more user interface controls are displayed on the client computer for selection by a user for placement on the user interface for the web-based software application;
receiving selection of an identifier for a first of the one or more user interface controls as the user interacts with the web-based development environment over the network connection;
in response to the received selection, retrieving the executable code module associated with the first user interface control from the library; and
storing the executable code module associated with the first user interface control in source code embodying the web-based software application.

17. The method defined in claim 17, further comprising:
billing each remotely located call center for their use of the shared call center infrastructure.

18. The method defined in claim 18, wherein billing is performed on a utility basis such as per seat per month, and wherein the method further comprising:
converting all customer calls to data, and routing voice traffic to the client call centers over respective data connections; and
providing access to client data centers over the respective data connections through the shared call center infrastructure.

19. The method defined in claim 16, further comprising:
centrally providing quality assurance functions on behalf of the client call centers;
centrally providing manpower scheduling functions on behalf of the client call centers;
centrally providing enterprise reporting functions on behalf of the client call centers; and
centrally providing network security functions on behalf of the client call centers.

20. A method for monitoring performance in a shared call center for one or more client call centers, the method comprising:
providing a shared call center infrastructure;
providing automatic call distribution functions to a plurality of remotely located call centers;
defining performance metrics that relate to threshold performance statistics established for an agent, wherein threshold performance statistics relate to a compensation package for the agent;
collecting performance statistics for the agent that reflect the agent's performance in accomplishing tasks;
comparing the collected performance statistics with the threshold performance statistics to characterize overall performance of the agent as satisfying one of a plurality of predefined performance categorizations; and
rendering on a computer display screen a graphical representation relating the satisfied performance categorization to the compensation package for the agent.
